(19) United States
(12) Patent Application Publication
(10) Pub. No.: US 2007/0054217 A1
(43) Pub. Date: Mar. 8, 2007

(54) Positive photosensitive composition and pattern-forming method using the same

(75) Inventors: Kunihiko Kodama, Shizuoka (JP); Kenji Wada, Shizuoka (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/514,957

(22) Filed: Sep. 5, 2006

(30) Foreign Application Priority Data
Sep. 5, 2005 (JP) P.2005-256514

(51) Int. Cl. G03C 1/00

(52) U.S. Cl. 430/270.1

(57) ABSTRACT

A positive photosensitive composition comprises: (A) a compound capable of generating an acid upon irradiation with actinic ray or radiation; and (B) a resin having a group capable of decomposing by action of an acid to increase solubility of the group in an alkali developer, wherein the resin (B) comprises: at least one methacrylate repeating unit; at least one acrylate repeating unit; and at least one repeating unit (Ba) having a diamantane structure.

### BACKGROUND OF THE INVENTION

1. Field of the Invention

The present invention relates to a positive photosensitive composition used in a manufacturing process of semiconductors, such as IC, manufacture of circuit substrates for liquid crystals, thermal heads and the like, and other photo-fabrication processes, and relates to a pattern-forming method using the same. More specifically, the invention relates to a positive photosensitive composition suitable for use in the case where far ultraviolet rays of 250 nm or less, preferably 220 nm or less, are used as exposure light sources, and electron beams are used as irradiation source, and relates to a pattern-forming method using the same.

2. Description of the Related Art

Chemical amplification photosensitive compositions are pattern-forming materials capable of generating an acid at an exposed area upon irradiation with actinic ray or radiation, e.g., far ultraviolet rays, changing the solubility in a developing solution of the irradiated area with actinic ray or radiation and that of the non-irradiated area by the reaction with the acid as a catalyst, and forming a pattern on a substrate.

When a KrF excimer laser is used as the exposure light source, resins having poly(hydroxystyrene) as a fundamental skeleton small in absorption in the region of 248 nm are mainly used, so that a high sensitivity, high resolution and good pattern is formed as compared with conventionally used naphthoquinonediazide/novolak resins.

On the other hand, when a light source of further shorter wavelength, e.g., an ArF excimer laser (193 nm), is used as the light source, even the chemically amplified photosensitive compositions are not sufficient, since compounds containing an aromatic group substantially show large absorption in the region of 193 nm.

To cope with this problem, resists containing a resin having an alicyclic hydrocarbon structure have been developed for an ArF excimer laser. JP-A-9-73173 discloses a resist composition containing an acid-decomposable resin having an adamantane structure. However, with the tendency of fining of a pattern, thinning of a resist film thickness has been necessary and dry etching resistance of a resist film is required. U.S. 2005/0074690A discloses a resin having a repeating unit having a diamantane structure.

However, these compounds are still insufficient and various improvements are desired. For example, it has come to be known that the fluctuation in temperature within a wafer in heating with a hot plate and the like after exposure (PEB) influences the obtained pattern, so that when a wafer having a large diameter is used, line widths of a pattern obtained in the wafer differ. It is desired to improve PEB temperature dependency like this.

Further, the compatibility of PEB temperature dependency and widening of exposure latitude are difficult, so that it is required to improve PEB temperature dependency and exposure latitude at the same time.

### SUMMARY OF THE INVENTION

Accordingly, an object of the invention is to provide a positive photosensitive composition in which PEB temperature dependency and exposure latitude are improved, and another object is to provide a pattern-forming method using the same.

The present invention is as follows.

(1) A positive photosensitive composition comprising:

(A) a compound capable of generating an acid upon irradiation with actinic ray or radiation; and

(B) a resin having a group capable of decomposing by action of an acid to increase solubility of the group in an alkali developer,

wherein the resin (B) has a diamantane structure, and comprises:

at least one methacrylate repeating unit; and

at least one acrylate repeating unit.

(2) The positive photosensitive composition as described in the above item (1),

wherein a repeating unit (Ba) having the diamantane structure in the resin (B) is at least one repeating unit selected from the following (Ba-1) and (Ba-2):

(Ba-1) a repeating unit having a group capable of decomposing by action of an acid to increase solubility of the group in an alkali developer, and having the diamantane structure in the group being desorbed by the action of an acid, and

(Ba-2) a repeating unit having the diamantane structure and not influenced by the action of an acid or an alkali.

(3) The positive photosensitive composition as described in the above item (1) or (2), wherein the resin of component (B) comprises: at least one repeating unit having a group capable of decomposing by the action of an acid to increase solubility of the group in an alkali developer; and at least one repeating unit selected from a repeating unit having a lactone group, and a repeating unit having a hydroxyl group or a cyano group.

(4) A pattern forming method comprising the processes of forming a photosensitive film with the positive photosensitive composition as described in the above item (1), (2) or (3); and exposing and developing the photosensitive film.

### BRIEF DESCRIPTION OF THE DRAWINGS

FIG. 1 is a schematic drawing of a laboratory apparatus of two-beam interference exposure.

1 denotes laser; 2 denotes a diaphragm; 3 denotes a shutter; 4, 5, 6 denote reflection mirrors; 7 denote a condenser lens; 8 denotes a prism; 9 denotes an immersion liquid; 10 denotes a wafer having an antireflection film and a resist film; and 11 denotes a wafer stage.

### DETAILED DESCRIPTION OF THE INVENTION

The best mode for carrying out the invention will be described below.

Incidentally, in the description of a group (an atomic group) in the specification of the invention, the description not referring to substitution or unsubstitution includes both a group not having a substituent and a group having a substituent. For example, “an alkyl group” includes not only an alkyl group having no substituent (an unsubstituted alkyl group) but also an alkyl group having a substituent (a substituted alkyl group).

[1] (A) A Compound Capable of Generating an Acid Upon Irradiation with Actinic Ray or Radiation:

A positive photosensitive composition in the invention contains a compound capable of generating an acid upon irradiation with actinic ray or radiation (hereinafter also referred to as “an acid generator”).

As such acid generators, photopolymerization initiators of photo-cationic polymerization, photopolymerization initiators of photo-radical polymerization, photo-decoloring agents of dyestuffs, photo-discoloring agents, well-known compounds capable of generating an acid upon irradiation with actinic ray or radiation that are used in micro-resists and the like, and the mixtures of these compounds can be optionally used.

For example, diazonium salt, phosphonium salt, sulfonium salt, iodonium salt, imidosulfonate, oximesulfonate, diazodisulfone, disulfone, and o-nitrobenzyl sulfonate can be exemplified.

Further, compounds obtained by introducing a group or a compound capable of generating an acid upon irradiation with actinic ray or radiation to the main chain or side chain of a polymer, e.g., compounds disclosed in U.S. Pat. No. 3,849,137, German Patent 3,914,407, JP-A-63-26653, JP-A-55-164824, JP-A-62-69263, JP-A-63-146038, JP-A-63-163452, JP-A-62-153853 and JP-A-63-146029 can be used.

The compounds capable of generating an acid by light as disclosed in U.S. Pat. No. 3,779,778 and EP-126,712 can also be used.

Of the compounds capable of generating an acid upon irradiation with actinic ray or radiation, compounds represented by the following formula (ZI), (ZII) or (ZIII) can be exemplified as preferred compounds.

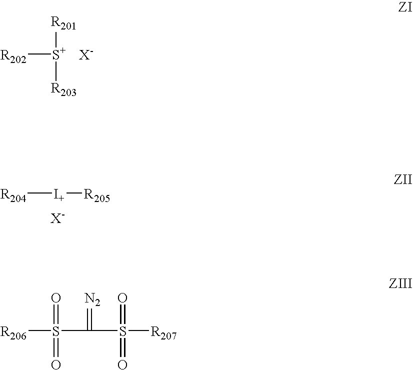

In formula (ZI), R₂₀₁, R₂₀₂ and R₂₀₃ each represents an organic group.

X⁻ represents a non-nucleophilic anion, preferably a sulfonate anion, a carboxylate anion, a bis(alkylsulfonyl)-imide anion, a tris(alkylsulfonyl)methide anion, BF⁴⁻, PF⁶⁻, SbF⁶⁻, etc., are exemplified, and preferably an organic anion having a carbon atom.

As the preferred organic anions, organic anions represented by the following formulae are exemplified.

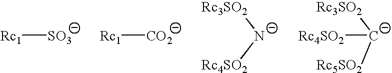

In the above formulae, Rc₁ represents an organic group.

As the organic group represented by Rc₁, an organic group having from 1 to 30 carbon atoms is exemplified, preferably an alkyl group, a cycloalkyl group, an aryl group, each of which groups may be substituted, or a group obtained by linking a plurality of these groups with a linking group such as a single bond, —O—, —CO₂—, —S—, —SO₃— or —SO₂N(Rd₁)- can be exemplified.

Rd₁ represents a hydrogen atom or an alkyl group.

Rc₃, Rc₄ and Rc₅ each represents an organic group.

As the organic groups represented by Rc₃, Rc₄ and Rc₅, the same organic groups as preferred organic groups in Rc₁ can be exemplified, and preferably a perfluoroalkyl group having from 1 to 4 carbon atoms.

Rc₃ and Rc₄ may be bonded to each other to form a ring.

As the group formed by bonding Rc₃ and Rc₄, an alkylene group, a cycloalkylene group, and an arylene group are exemplified, and preferably a perfluoroalkylene group having from 2 to 4 carbon atoms.

As the organic groups represented by Rc₁, Rc₃ to Rc₅, preferably an alkyl group substituted with a fluorine atom or a fluoroalkyl group on the 1-position, and a phenyl group substituted with a fluorine atom or a fluoroalkyl group can be exemplified. By the presence of a fluorine atom or a fluoroalkyl group, the acidity of the acid generated with light irradiation increases to enhance sensitivity. Further, by the formation of a ring by the bonding of Rc₃ and Rc₄, the acidity of the acid generated with light irradiation preferably increases to improve sensitivity.

In formula (ZI), the number of carbon atoms of the organic groups represented by R₂₀₁, R₂₀₂ and R₂₀₃ is generally from 1 to 30, and preferably from 1 to 20.

Any two of R₂₀₁, R₂₀₂ and R₂₀₃ may be bonded to each other to form a cyclic structure, and an oxygen atom, a sulfur atom, an ester bond, an amido bond or a carbonyl group may be contained in the ring.

As the group formed by any two of R₂₀₁, R₂₀₂ and R₂₀₃ by bonding, an alkylene group (e.g., a butylene group and a pentylene group) can be exemplified.

As the specific examples of the organic groups represented by R₂₀₁, R₂₀₂ and R₂₀₃, the corresponding groups in compounds (ZI-1), (ZI-2) and (ZI-3) described later can be exemplified.

A compound represented by formula (ZI) may be a compound having a plurality of structures represented by formula (ZI). For instance, a compound represented by formula (ZI) may be a compound having a structure that at least one of R₂₀₁, R₂₀₂ and R₂₀₃ is bonded to at least one of R₂₀₁, R₂₀₂ and R₂₀₃ of another compound represented by formula (ZI).

As preferred components (ZI), the following compounds (ZI-1) (ZI-2) and (ZI-3) can be exemplified.

Compound (ZI-1) is an arylsulfonium compound in the case where at least one of R₂₀₁, R₂₀₂ and R₂₀₃ in formula (ZI) represents an aryl group, that is, a compound having arylsulfonium as the cation.

All of R₂₀₁, R₂₀₂ and R₂₀₃ of the arylsulfonium compound may be aryl groups, or a part of R₂₀₁, R₂₀₂ and R₂₀₃ may be an aryl group and the remainder may be an alkyl group or a cycloalkyl group.

As the arylsulfonium compound, e.g., a triarylsulfonium compound, a diarylalkylsulfonium compound, an aryldialkylsulfonium compound, a diarylcycloalkylsulfonium compound, and an aryldicycloalkylsulfonium compound can be exemplified.

As the aryl group of the arylsulfonium compound, an aryl group, e.g., a phenyl group and a naphthyl group, and a heteroaryl group, e.g., an indole residue and a pyrrole residue are preferred, and a phenyl group and an indole residue are more preferred. When the arylsulfonium compound has two or more aryl groups, these two or more aryl groups may be the same or different.

The alkyl group that the arylsulfonium compound may have according to necessity is preferably a straight chain or branched alkyl group having from 1 to 15 carbon atoms, e.g., a methyl group, an ethyl group, a propyl group, an n-butyl group, a sec-butyl group, a t-butyl group, etc., can be exemplified.

The cycloalkyl group that the arylsulfonium compound may have according to necessity is preferably a cycloalkyl group having from 3 to 15 carbon atoms, e.g., a cyclopropyl group, a cyclobutyl group, a cyclohexyl group, etc., can be exemplified.

The aryl group, alkyl group and cycloalkyl group represented by R₂₀₁, R₂₀₂ and R₂₀₃ may have a substituent, e.g., an alkyl group (e.g., having from 1 to 15 carbon atoms), a cycloalkyl group (e.g., having from 3 to 15 carbon atoms), an aryl group (e.g., having from 6 to 14 carbon atoms), an alkoxyl group (e.g., having from 1 to 15 carbon atoms), a halogen atom, a hydroxyl group, and a phenylthio group are exemplified as the substituents. The preferred substituents are a straight chain or branched alkyl group having from 1 to 12 carbon atoms, a cycloalkyl group having from 3 to 12 carbon atoms, and a straight chain, branched, or cyclic alkoxyl group having from 1 to 12 carbon atoms, and the more preferred substituents are an alkyl group having from 1 to 4 carbon atoms, and an alkoxyl group having from 1 to 4 carbon atoms. The substituent may be substituted on any one of three of R₂₀₁, R₂₀₂ and R₂₀₃, or may be substituted on all of the three. When R₂₀₁, R₂₀₂ and R₂₀₃ each represents an aryl group, it is preferred that the substituent is substituted on the p-position of the aryl group.

Compound (ZI-2) is described below.

Compound (ZI-2) is a compound in the case where R₂₀₁, R₂₀₂ and R₂₀₃ in formula (ZI) each represents an organic group not having an aromatic ring. The aromatic ring here also includes an aromatic ring containing a hetero atom.

The organic group not having an aromatic ring represented by R₂₀₁, R₂₀₂ and R₂₀₃ generally has from 1 to 30 carbon atoms, and preferably from 1 to 20 carbon atoms.

R₂₀₁, R₂₀₂ and R₂₀₃ each preferably represents an alkyl group, a cycloalkyl group, an allyl group, or a vinyl group, more preferably represents a straight chain, branched or cyclic 2-oxoalkyl group, or an alkoxycarbonylmethyl group, and still more preferably a straight chain or branched 2-oxoalkyl group.

The alkyl group represented by R₂₀₁, R₂₀₂ and R₂₀₃ may be either straight chain or branched, preferably a straight chain or branched alkyl group having from 1 to 10 carbon atoms, e.g., a methyl group, an ethyl group, a propyl group, a butyl group, and a pentyl group can be exemplified. The alkyl group represented by R₂₀₁, R₂₀₂ and R₂₀₃ is more preferably a straight chain or branched 2-oxoalkyl group or an alkoxycarbonylmethyl group.

The cycloalkyl group represented by R₂₀₁, R₂₀₂ and R₂₀₃ is preferably a cycloalkyl group having from 3 to 10 carbon atoms, e.g., a cyclopentyl group, a cyclohexyl group and a norbonyl group can be exemplified. The cycloalkyl group represented by R₂₀₁, R₂₀₂ and R₂₀₃ is more preferably a cyclic 2-oxoalkyl group.

As the straight chain, branched or cyclic 2-oxoalkyl group represented by R₂₀₁, R₂₀₂ and R₂₀₃, preferably a group having >C═O on the 2-position of the above alkyl group and the cycloalkyl group can be exemplified.

As the alkoxyl group in the alkoxycarbonylmethyl group represented by R₂₀₁, R₂₀₂ and R₂₀₃, preferably an alkoxyl group having from 1 to 5 carbon atoms, e.g., a methoxy group, an ethoxy group, a propoxy group, a butoxy group, and a pentoxy group can be exemplified.

R₂₀₁, R₂₀₂ and R₂₀₃ may further be substituted with a halogen atom, an alkoxyl group (e.g., having from 1 to 5 carbon atoms), a hydroxyl group, a cyano group, or a nitro group.

Compound (ZI-3) is a compound represented by the following formula (ZI-3) and has a phenacylsulfonium salt structure.

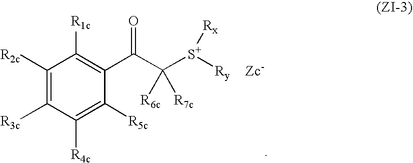

In formula (ZI-3), R_{1c}, R_{2c}, R_{3c}, R_{4c} and R_{5c} each represents a hydrogen atom, an alkyl group, a cycloalkyl group, an alkoxy group, or a halogen atom.

R_{6c} and R_{7c} each represents a hydrogen atom, an alkyl group or a cycloalkyl group.

Rₓ and R_{y} each represents an alkyl group, a cycloalkyl group, an allyl group, or a vinyl group.

Any two or more of R_{1c} to R_{5c}, R_{6c} and R_{7c}, and Rₓ and R_{y} may be bonded to each other to form cyclic structures, respectively, and the cyclic structures may contain an oxygen atom, a sulfur atom, an ester bond, or an amido bond. As the groups formed by any two or more of R_{1c} to R_{5c}, R_{6c} and R_{7c}, and Rₓ and R_{y}, by bonding, a butylene group, a pentylene group, etc., can be exemplified.

Z_{c}⁻ represents a non-nucleophilic anion, and the same anion as the non-nucleophilic anion represented by X⁻ in formula (ZI) can be exemplified.

The alkyl group represented by R_{1c} to R_{7c} may be either straight chain or branched, e.g., a straight chain or branched alkyl group having from 1 to 20, preferably from 1 to 12, carbon atoms, e.g., a methyl group, an ethyl group, a straight chain or branched propyl group, a straight chain or branched butyl group, and a straight chain or branched pentyl group can be exemplified.

The cycloalkyl group represented by R_{1c} to R_{7c} is preferably a cycloalkyl group having from 3 to 8 carbon atoms, e.g., a cyclopentyl group and a cyclohexyl group can be exemplified.

The alkoxyl group represented by R_{1c} to R_{5c} may be any of straight chain, branched, or cyclic, e.g., an alkoxyl group having from 1 to 10 carbon atoms, preferably a straight chain or branched alkoxyl group having from 1 to 5 carbon atoms, e.g., a methoxy group, an ethoxy group, a straight chain or branched propoxy group, a straight chain or branched butoxy group, and a straight chain or branched pentoxy group, a cyclic alkoxyl group having from 3 to 8 carbon atoms, e.g., a cyclopentyloxy group, and a cyclohexyloxy group can be exemplified.

Preferably any of R_{1c} to R_{5c} represents a straight chain or branched alkyl group, a cycloalkyl group, or a straight chain, branched, or cyclic alkoxyl group, and more preferably the sum total of the carbon atoms of R_{1c} to R_{5c} is from 2 to 15. By selecting such substituents, the solubility in a solvent is bettered and the generation of particles during preservation can be restrained.

As the alkyl group represented by Rₓ and R_{y}, the same alkyl group as represented by R_{1c} to R_{7c} can be exemplified. The alkyl group represented by Rₓ and R_{y} is more preferably a straight chain or branched 2-oxoalkyl group or an alkoxycarbonylmethyl group.

As the cycloalkyl group represented by Rₓ and R_{y}, the same cycloalkyl group as represented by R_{1c} to R_{7c} can be exemplified. The cycloalkyl group represented by Rₓ and R_{y} is more preferably a cyclic 2-oxoalkyl group.

As the straight chain, branched, or cyclic 2-oxoalkyl group, a group having >C═O on the 2-position of the alkyl group or the cycloalkyl group represented by R_{1c} to R_{7c} can be exemplified.

As the alkoxyl group in the alkoxycarbonylmethyl group, the same alkoxyl group as represented by R_{1c} to R_{5c} can be exemplified.

Rₓ and R_{y} each preferably represents an alkyl group having 4 or more carbon atoms, more preferably 6 or more carbon atoms, and still more preferably an alkyl group having 8 or more carbon atoms.

In formulae (ZII) and (ZIII), R₂₀₄, R₂₀₅, R₂₀₆ and R₂₀₇ each represents an aryl group, an alkyl group, or a cycloalkyl group.

The aryl group represented by R₂₀₄ to R₂₀₇ is preferably an aryl group, e.g., a phenyl group or a naphthyl group, or a heteroaryl group, e.g., an indole residue or a pyrrole residue, and more preferably a phenyl group or an indole residue.

The alkyl group represented by R₂₀₄ to R₂₀₇ may be either straight chain or branched, and preferably a straight chain or branched alkyl group having from 1 to 10 carbon atoms, e.g., a methyl group, an ethyl group, a propyl group, a butyl group, and a pentyl group can be exemplified.

The cycloalkyl group represented by R₂₀₄ to R₂₀₇ is preferably a cycloalkyl group having from 3 to 10 carbon atoms, e.g., a cyclopentyl group, a cyclohexyl group, and a norbonyl group can be exemplified.

As the examples of the substituents that R₂₀₄ to R₂₀₇ may have, e.g., an alkyl group (e.g., having from 1 to 15 carbon atoms), a cycloalkyl group (e.g., having from 3 to 15 carbon atoms), an aryl group (e.g., having from 6 to 15 carbon atoms), an alkoxyl group (e.g., having from 1 to 15 carbon atoms), a halogen atom, a hydroxyl group, a phenylthio group, etc., can be exemplified.

X⁻ represents a non-nucleophilic anion, and the same anion as the non-nucleophilic anion represented by X⁻ in formula (ZI) can be exemplified.

Of the compounds capable of generating an acid upon irradiation with actinic ray or radiation, compounds represented by the following formula (ZIV), (ZV) or (ZVI) can further be exemplified as preferred compounds.

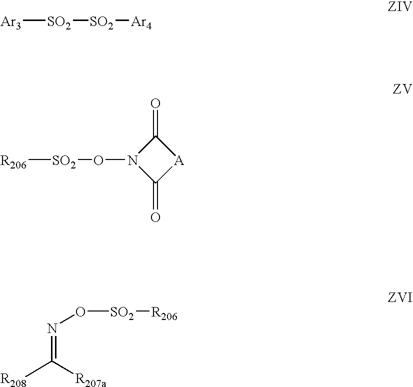

In formulae (ZIV) to (ZVI), Ar₃ and Ar₄ each represents an aryl group.

R₂₀₆ represents an alkyl group, a cycloalkyl group, or an aryl group.

R₂₀₇ₐ and R₂₀₈ each represents an alkyl group, a cycloalkyl group, an aryl group, or an electron attractive group. R₂₀₇ₐ preferably represents an aryl group. R₂₀₈ preferably represents an electron attractive group, and more preferably a cyano group or a fluoroalkyl group.

A represents an alkylene group, an alkenylene group, or an arylene group.

Of the compounds capable of generating an acid upon irradiation with actinic ray or radiation, more preferred compounds are the compounds represented by any of formulae (ZI), (ZII) and (ZIII).

Of the compounds capable of generating an acid upon irradiation with actinic ray or radiation, particularly preferred examples are shown below.

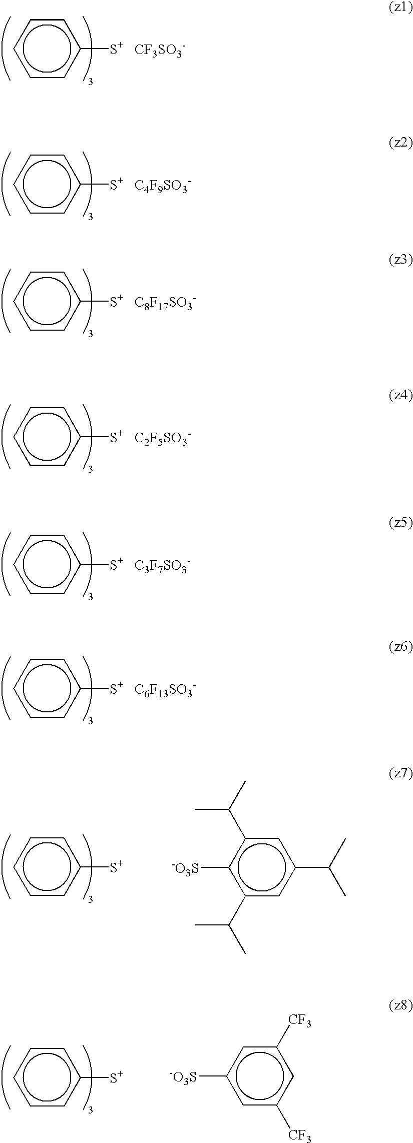

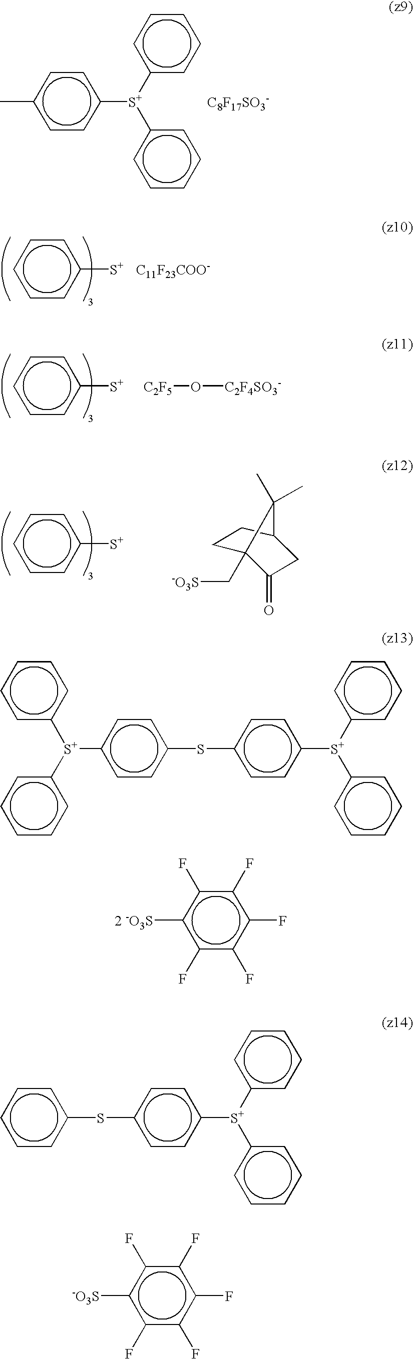

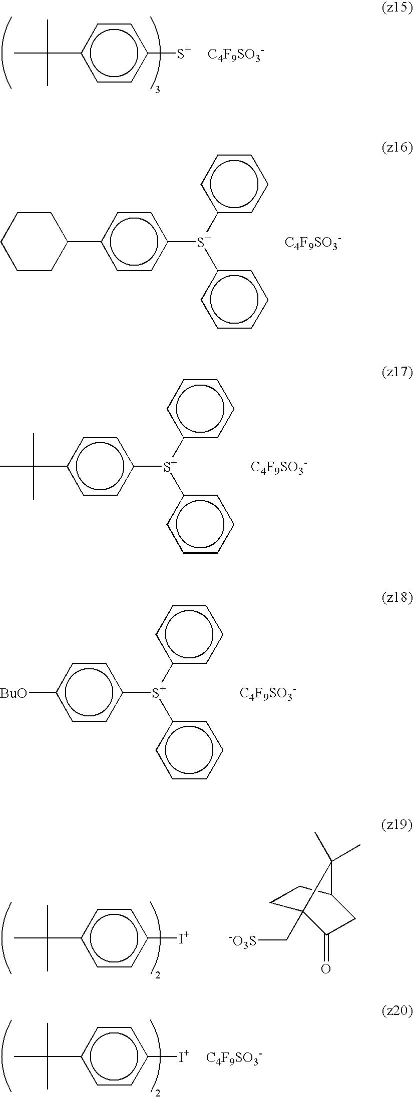

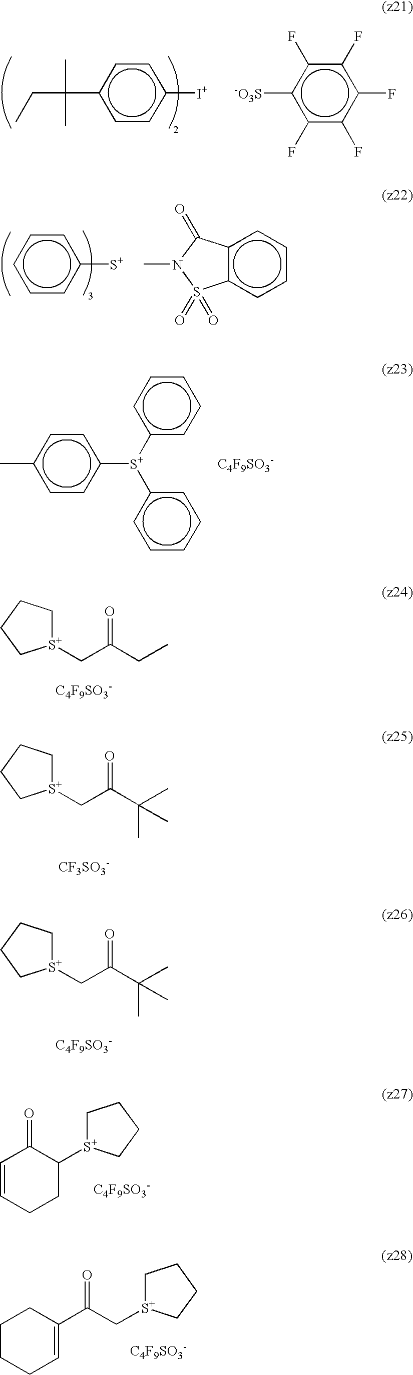

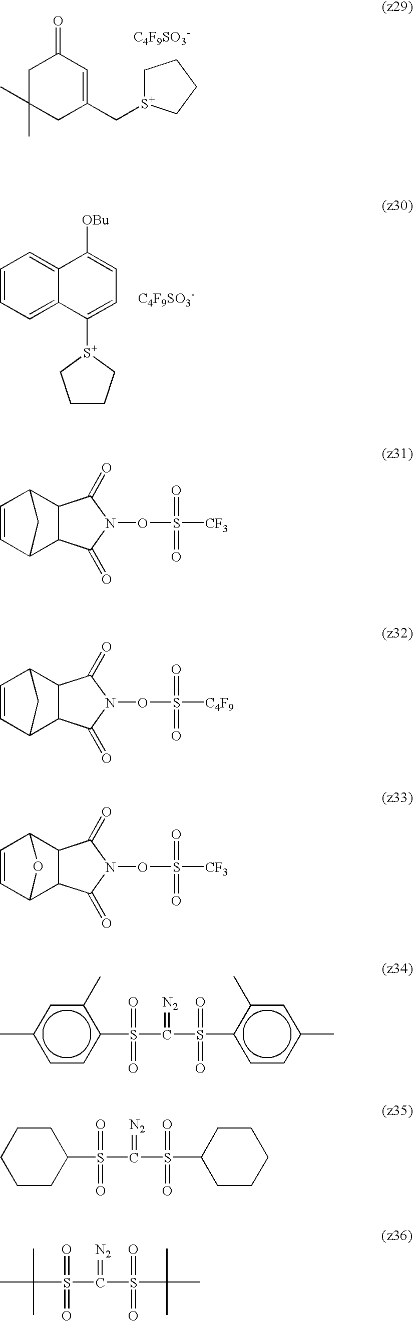

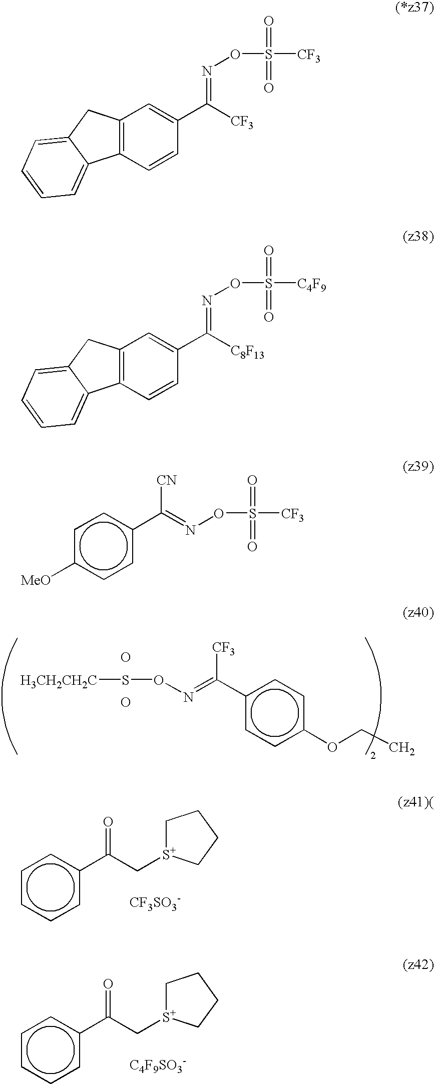

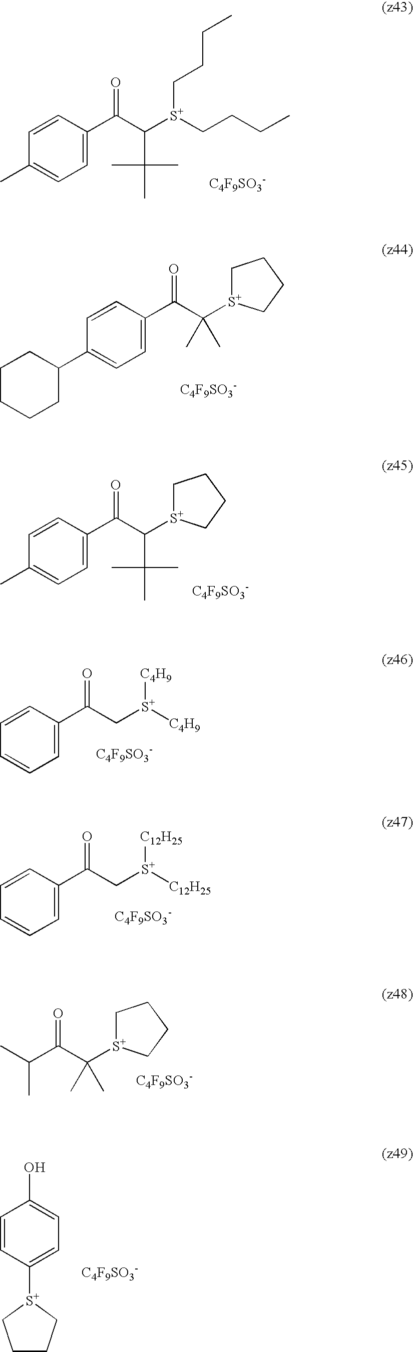

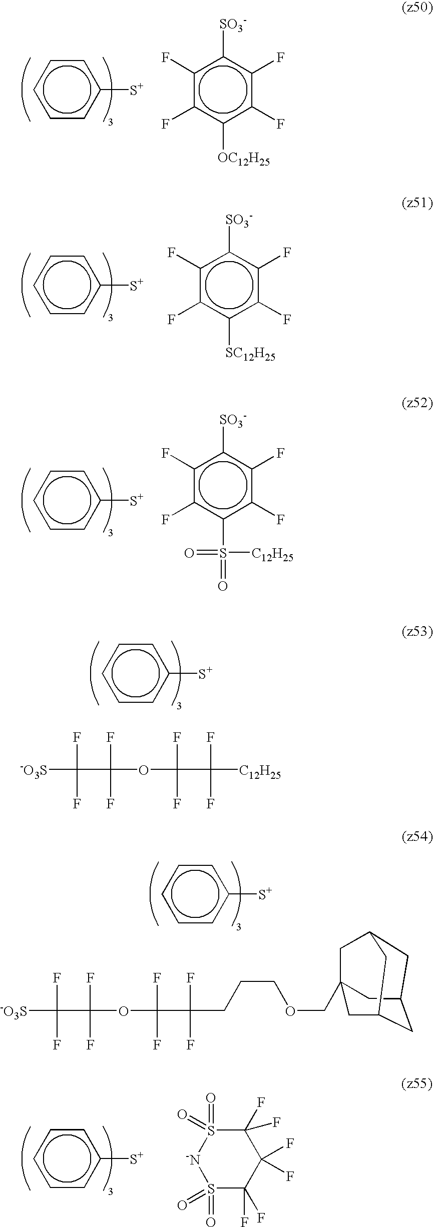

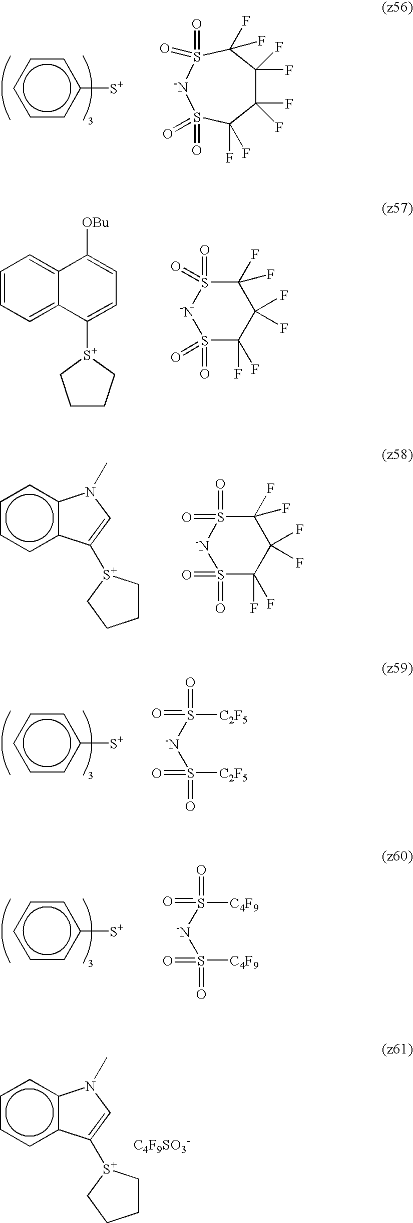

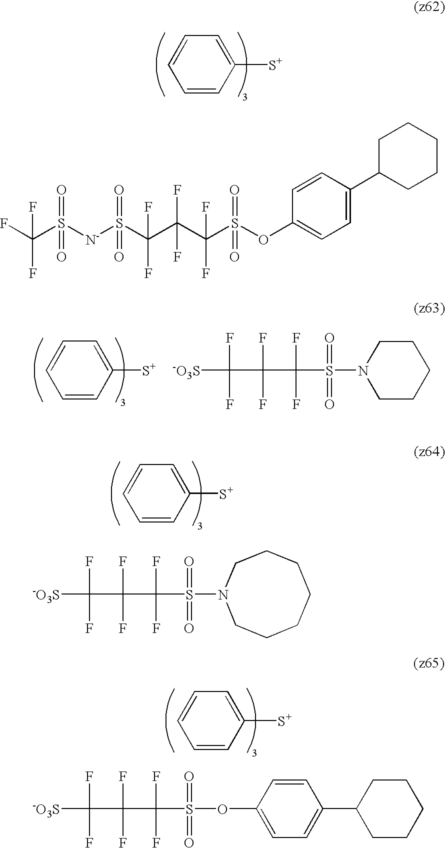

The acid generators can be used one kind alone, or two or more kinds can be used in combination. When two or more compounds are used in combination, it is preferred to combine compounds capable of generating two kinds of organic acids in which the total atom number exclusive of a hydrogen atom differs by 2 or more.

The content of the acid generators is preferably from 0.1 to 20 mass % based on the total solids content of the positive photosensitive composition, more preferably from 0.5 to 10 mass %, and still more preferably from 1 to 7 mass %.

[2] (B) A Resin Having a Group Capable of Decomposing by the Action of an Acid to Increase Solubility in an Alkali Developer, which is a Resin Having at Least One Methacrylate Repeating Unit, at Least One Acrylate Repeating Unit, and at Least One Repeating Unit Having a Diamantane Structure (Ba):

A positive photosensitive composition in the invention contains a resin having a group capable of decomposing by the action of an acid to increase solubility in an alkali developer, and having at least one methacrylate repeating unit, at least one acrylate repeating unit, and at least one repeating unit having a diamantane structure (Ba) (hereinafter also referred to as “the resin of component (B)”).

The resin of component (B) is a resin having at least one group capable of decomposing by the action of an acid to increase solubility in an alkali developer (hereinafter also referred to as “an acid-decomposable group”). The acid-decomposable group may be contained in a repeating unit having a diamantane structure (Ba), or may be contained in other repeating units. The acid-decomposable group may also be contained in a methacrylate repeating unit or may be contained in an acrylate repeating unit.

As the acid-decomposable group, e.g., a group in which the hydrogen atom of an alkali-soluble group, e.g., a carboxyl group, a hydroxyl group, etc., is protected with a group that is desorbed by the action of an acid can be exemplified.

As the group that is desorbed by the action of an acid, e.g., —C(R₃₆)(R₃₇)(R₃₈), —C(R₃₆)(R₃₇)(OR₃₉), —C(R₀₁)(R₀₂)(OR₃₉) and the like can be exemplified.

In the formulae, R₃₆ to R₃₉ each represents an alkyl group, a cycloalkyl group, an aryl group, an aralkyl group, or an alkenyl group. R₃₆ and R₃₇ may be bonded to each other to form a ring.

R₀₁ and R₀₂ each represents a hydrogen atom, an alkyl group, a cycloalkyl group, an aryl group, an aralkyl group, or an alkenyl group.

The repeating unit having a diamantane structure (Ba) is preferably selected from the repeating units shown below.
(Ba-1) A repeating unit having an acid-decomposable group and having a diamantane structure in a group that is desorbed by the action of an acid of the acid-decomposable group
(Ba-2) A repeating unit having a diamantane structure and not influenced by the action of an acid or an alkali

Repeating unit (Ba-1) or (Ba-2) may each have a substituent, and an alkyl group and a polar functional group can be exemplified as preferred examples of the substituents. Repeating unit (Ba-1) or (Ba-2) is preferably a repeating unit having such a structure that a polar functional group is substituted on diamantane. As the examples of the polar functional groups, a hydroxyl group, a carboxyl group, a cyano group, an amido group, a sulfonamido group, a sulfonylimido group, etc., are exemplified, and preferably a hydroxyl group.

(Ba-1) A Repeating Unit Having an Acid-Decomposable Group and Having a Diamantane Structure in a Group that is Desorbed by the Action of an Acid of the Acid-Decomposable Group:

The group that is desorbed by the action of an acid having a diamantane structure is preferably represented by any of the following formulae (DpI) to (DpV). The repeating unit having an acid-decomposable group and having a diamantane structure in a group that is desorbed by the action of an acid of the acid-decomposable group is preferably a repeating unit having an acid-decomposable group in which the hydrogen atom of an alkali-soluble group is protected with a group represented by any of formulae (DpI) to (DpV).

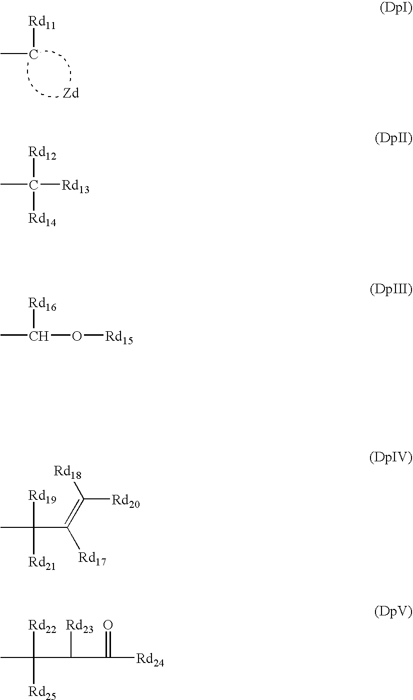

In formulae (DpI) to (DpV), Rd₁₁ represents a methyl group, an ethyl group, an n-propyl group, an isopropyl group, an n-butyl group, an isobutyl group, or a sec-butyl group; and Zd represents an atomic group necessary to form a diamantyl group together with a carbon atom.

Rd₁₂, Rd₁₃, Rd₁₄, Rd₁₅ and Rd₁₆ each represents a straight chain or branched alkyl group having from 1 to 4 carbon atoms, or a cycloalkyl group, provided that at least one of Rd₁₂ to Rd₁₄, or either Rd₁₅ or Rd₁₆, represents a diamantyl group or a group having a diamantyl group (preferably an alkyl group having a diamantyl group having from 1 to 5 carbon atoms).

Rd₁₇, Rd₁₈, Rd₁₉, Rd₂₀ and Rd₂₁ each represents a hydrogen atom, a straight chain or branched alkyl group having from 1 to 4 carbon atoms, or a cycloalkyl group, provided that at least one of Rd₁₇ to Rd₂₁ represents a diamantyl group or a group having a diamantyl group (preferably an alkyl group having a diamantyl group having from 1 to 5 carbon atoms), and either R₁₉ or Rd₂₁ represents a straight chain or branched alkyl group having from 1 to 4 carbon atoms, or a cycloalkyl group.

Rd₂₂, Rd₂₃, Rd₂₄ and Rd₂₅ each represents a hydrogen atom, a straight chain or branched alkyl group having from 1 to 4 carbon atoms, or a cycloalkyl group, provided that at least one of Rd₂₂ to Rd₂₅ represents a diamantyl group or a group having a diamantyl group (preferably an alkyl group having a diamantyl group having from 1 to 5 carbon atoms), and Rd₂₃ and Rd₂₄ may be bonded to each other to form a ring.

The repeating unit having an acid-decomposable group in which the hydrogen atom of an alkali-soluble group is protected with a group represented by any of formulae (DpI) to (DpV) is preferably a repeating unit represented by the following formula (DPA).

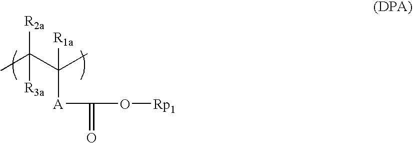

In formula (DPA), R₁ₐ, R₂ₐ and R₃ₐ each represents a hydrogen atom, a halogen atom, or a straight chain or branched alkyl group having from 1 to 4 carbon atoms. The alkyl group represented by R₁ₐ, R₂ₐ and R₃ₐ may be substituted with a fluorine atom, a hydroxyl group, etc.

A represents a single group or a combination comprising two or more groups selected from the group consisting of a single bond, an alkylene group, an ether group, a thioether group, a carbonyl group, an ester group, an amido group, a sulfonamido group, a urethane group, and a urea group, and preferably a single bond.

Rp₁ represents a group represented by any of formulae (DpI) to (DpV).

The preferred examples of repeating unit (Ba-1) are shown below, but the invention is not restricted thereto.

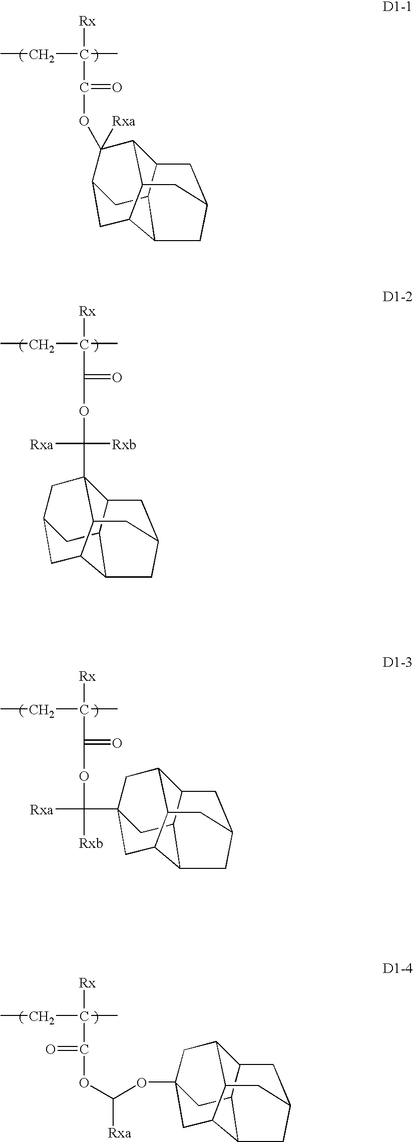

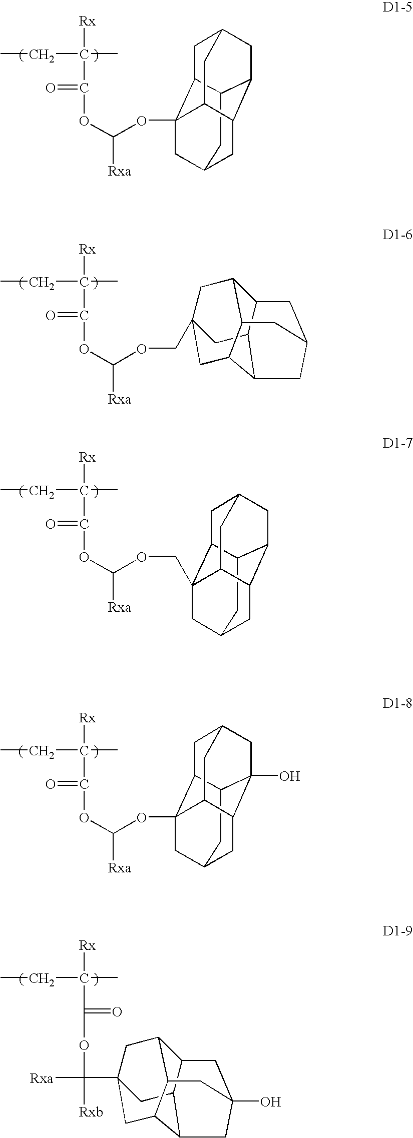

In the above specific examples, Rx represents H, CH₃, CF₃, or CH₂OH.

Rxa and Rxb each represents a straight chain or branched alkyl group having from 1 to 6 carbon atoms, or a cycloalkyl group having from 3 to 6 carbon atoms, and the alkyl chain or the cycloalkyl chain may contain a hetero atom such as oxygen or sulfur.

Of the above specific examples of repeating unit (Ba-1), (D1-1), (D1-2) and (D1-3) are more preferred.

(Ba-2) A Repeating Unit Having a Diamantane Structure and Not Influenced by the Action of an Acid or an Alkali:

In the invention, the terminology “not influenced by the action of an acid or an alkali” means that a positive photosensitive composition of the invention does not show reactivity to the action of an acid or an alkali in generally used processes, or hardly reacts, that is, the positive photosensitive composition does not substantially have a group that contributes to image formation by the action of an acid or an alkali. For example, in the case of a positive chemical amplification resist, an acid generator is decomposed in an exposure area in exposure process to thereby generate an acid. The acid decomposes a resin having an acid-decomposable group in the post baking process and generates an alkali-soluble group, as a result the exposed area alone becomes alkali-developable, and the exposed area is selectively developed in an alkali developing process to form a pattern. Repeating unit (Ba-2) does not show reactivity to the action of an acid or an alkali in exposure, post baking or development process, or hardly reacts, and substantially does not have a group contributing to contrast change by dissolution.

Repeating unit (Ba-2) is preferably represented by the following formula (DPB)

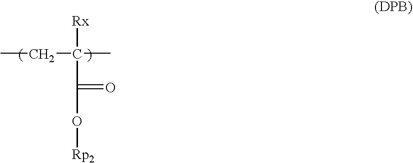

In formula (DPB), Rx represents H, CH₃, CF₃, or CH₂OH.

Rp₂ represents a diamantyl group or a group having a diamantyl group (preferably an alkyl group having a diamantyl group and from 1 to 5 carbon atoms), which is a group not desorbed from the oxygen atom by the action of an acid or an alkali. As the group that is not desorbed from the oxygen atom by the action of an acid or an alkali, e.g., a group by a primary or secondary ester bond can be exemplified. Further, as (D2-1), (D2-2), (D2-5) to (D2-14) as shown below, tertiary ester structures of linking to the tertiary carbon atoms on the 1-, 4-, 6-, and 9-positions of a diamantyl group by ester bonds also do not show acid decomposability, and do not substantially contribute to image formation by the action of an acid, so that they can be exemplified as preferred structures.

The preferred specific examples of repeating unit (Ba-2) are shown below, but the invention is not restricted thereto.

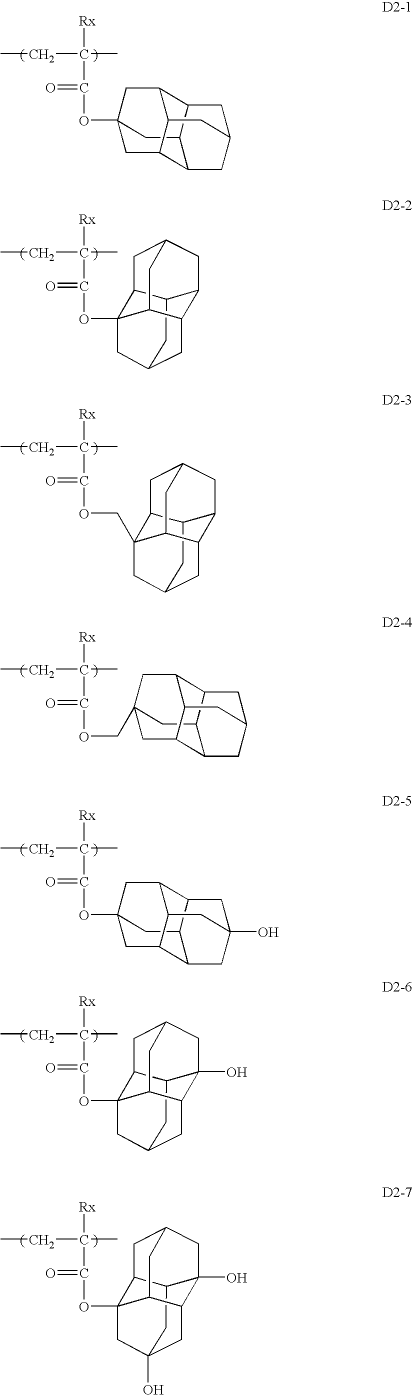

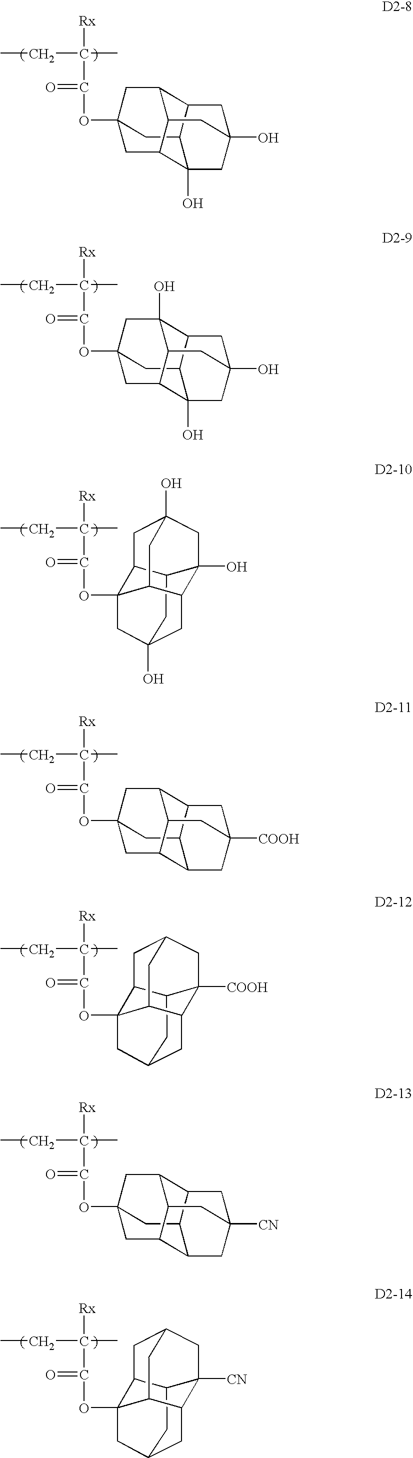

In the above specific examples, Rx represents H, CH₃, CF₃, or CH₂OH.

Of the above specific examples of repeating unit (Ba-2), (D2-1), (D2-2), (D2-5) and (D2-6) are more preferred.

When a repeating unit (Ba) having a diamantane structure does not have an acid-decomposable group, the resin of component (B) has an acid-decomposable group in other repeating units. The resin of component (B) may have a repeating unit having an acid-decomposable group and having a diamantane structure in a group that is desorbed by the action of an acid of the acid-decomposable group (Ba-1), and other repeating unit having an acid-decomposable group. The preferred group as the acid-decomposable group is a group obtained by substituting the hydrogen atom of a —COOH group or an —OH group with a group that is desorbed by an acid. In the invention, an acetal group and a tertiary ester group are preferred as acid-decomposable groups.

A host resin in the case where an acid-decomposable group is bonded as the side chain is an alkali-soluble resin having an —OH or —COOH group on the side chain, e.g., alkali-soluble resins described later can be exemplified.

The dissolving rate of alkali-soluble resins is preferably 170 Å/sec or more when measured with 0.261N tetramethylammonium hydroxide (TMAH) at 23° C., and especially preferably 330 Å/sec or more.

From such a point of view, particularly preferred alkali-soluble resins are alkali-soluble resins having a hydroxystyrene structural unit such as o-, m-, p-poly(hydroxystyrene) and copolymers thereof, hydrogenated poly(hydroxystyrene), halogen- or alkyl-substituted poly(hydroxystyrene), a partially O-alkylated or O-acylated product of poly(hydroxystyrene), styrene-hydroxystyrene copolymers, α-methylstyrene-hydroxystyrene copolymers, and hydrogenated novolak resins, and alkali-soluble resins having a repeating unit having a carboxyl group such as a (meth)acrylic acid, or a norbornenecarboxylic acid.

The resin of component (B) can be obtained, as disclosed in EP-254853, JP-A-2-25850, JP-A-3-223860 and JP-A-4-251259, by the reaction of an alkali-soluble group with the precursor of a group capable of decomposing by an acid, or by the copolymerization of an alkali-soluble resin monomer having an acid-decomposable group bonded thereto and various kinds of monomers.

As other repeating unit having an acid-decomposable group, at least one selected from the repeating units in which an alkali-soluble group is protected with a chain-like tertiary alkyl group, e.g., a t-butyl group or a t-pentyl group, or protected with a group having a partial structure containing alicyclic hydrocarbon represented by any of the following formulae (pI) to (pV) is preferred.

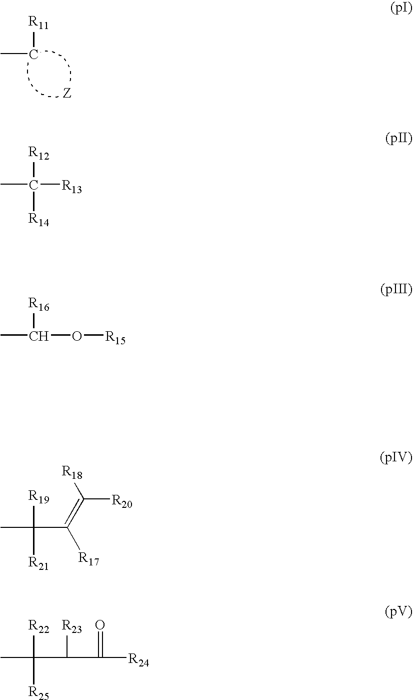

In formulae (pI) to (pV), R₁ₗ represents a methyl group, an ethyl group, an n-propyl group, an isopropyl group, an n-butyl group, an isobutyl group, or a sec-butyl group; and Z represents an atomic group necessary to form a cycloalkyl group together with a carbon atom.

R₁₂, R₁₃, R₁₄, R₁₅ and R₁₆ each represents a straight chain or branched alkyl group having from 1 to 4 carbon atoms, or a cycloalkyl group, provided that at least one of R₁₂ to R₁₄, or either R₁₅ or R₁₆ represents a cycloalkyl group.

R₁₇, R₁₈, R₁₉, R₂₀ and R₂₁ each represents a hydrogen atom, a straight chain or branched alkyl group having from 1 to 4 carbon atoms, or a cycloalkyl group, provided that at least one of R₁₇ to R₂₁ represents a cycloalkyl group, and either R₁₉ or R₂₁ represents a straight chain or branched alkyl group having from 1 to 4 carbon atoms, or a cycloalkyl group.

R₂₂, R₂₃, R₂₄ and R₂₅ each represents a hydrogen atom, a straight chain or branched alkyl group having from 1 to 4 carbon atoms, or a cycloalkyl group, provided that at least one of R₂₂ to R₂₅ represents a cycloalkyl group, and R₂₃ and R₂₄ may be bonded to each other to form a ring.

In formulae (pI) to (pV), as the alkyl group represented by R₁₂ to R₂₅, a straight chain or branched alkyl group having from 1 to 4 carbon atoms, e.g., a methyl group, an ethyl group, a propyl group, etc., can be exemplified.

The cycloalkyl group represented by R₁₂ to R₂₅ or the cycloalkyl group formed by Z together with carbon atoms may be monocyclic or polycyclic. Specifically, groups having a monocyclic, bicyclic, tricyclic or tetracyclic structure having 5 or more carbon atoms can be exemplified. The number of carbon atoms of these cycloalkyl groups is preferably from 6 to 30, and especially preferably from 7 to 25. These cycloalkyl groups may have a substituent.

As the preferred cycloalkyl groups, an adamantyl group, a noradamantyl group, a decalin residue, a tricyclodecanyl group, a tetracyclododecanyl group, a norbornyl group, a cedrol group, a cyclopentyl group, a cyclohexyl group, a cycloheptyl group, a cyclooctyl group, a cyclodecanyl group, and a cyclododecanyl group are exemplified. More preferred groups are an adamantyl group, a norbornyl group, a cyclohexyl group, a cyclopentyl group, a tetracyclododecanyl group, and a tricyclodecanyl group.

As further substituents of these alkyl group and cycloalkyl group, an alkyl group (having from 1 to 4 carbon atoms), a halogen atom, a hydroxyl group, an alkoxyl group (having from 1 to 4 carbon atoms), a carboxyl group, and an alkoxycarbonyl group (having from 2 to 6 carbon atoms) can be exemplified. These alkyl group, alkoxyl group, and alkoxycarbonyl group may further be substituted with a hydroxyl group, a halogen atom, and an alkoxyl group.

The structures represented by formulae (pI) to (pV) in the above resins are used for the protection of the alkali-soluble group. Specifically, the structures in which the hydrogen atoms of a carboxylic acid group, a sulfonic acid group, a phenol group, and a thiol group are substituted with the structures represented by formulae (pI) to (pV) are exemplified, and the structures in which the hydrogen atoms of a carboxylic acid group and a sulfonic acid group are substituted with the structures represented by formulae (pI) to (pV) are preferred.

The repeating unit having the alkali-soluble group protected with the structure represented by any of formulae (pI) to (pVI) is preferably a repeating unit represented by the following formula (pA).

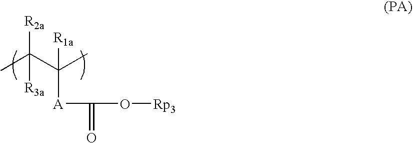

In formula (pA), R₁ₐ, R₂ₐ and R₃ₐ each represents a hydrogen atom, a halogen atom, or a straight chain or branched alkyl group having from 1 to 4 carbon atoms, and the alkyl group represented by R₁ₐ, R₂ₐ and R₃ₐ may be substituted with a fluorine atom or a hydroxyl group.

A represents a single group or the combination of two or more groups selected from the group consisting of a single bond, an alkylene group, an ether group, a thioether group, a carbonyl group, an ester group, an amido group, a sulfonamido group, a urethane group and a urea group, and preferably a single bond.

Rp₃ represents any group of formulae (pI) to (pV).

The repeating units represented by formula (pA) are more preferably repeating units by 2-alkyl-2-adamantyl(meth)acrylate, 2-(1-adamantyl)-2-propyl(meth)acrylate, 1-alkyl-1-cyclopentyl(meth)acrylate, and 1-alkyl-1-cyclohexyl(meth)acrylate.

The specific examples of the repeating units represented by formula (pA) are shown below.
(In the formulae, Rx represents H, CH₃, CF₃, CH₂OH, or Rxa, and Rxa represents an alkyl group having from 1 to 4 carbon atoms.)

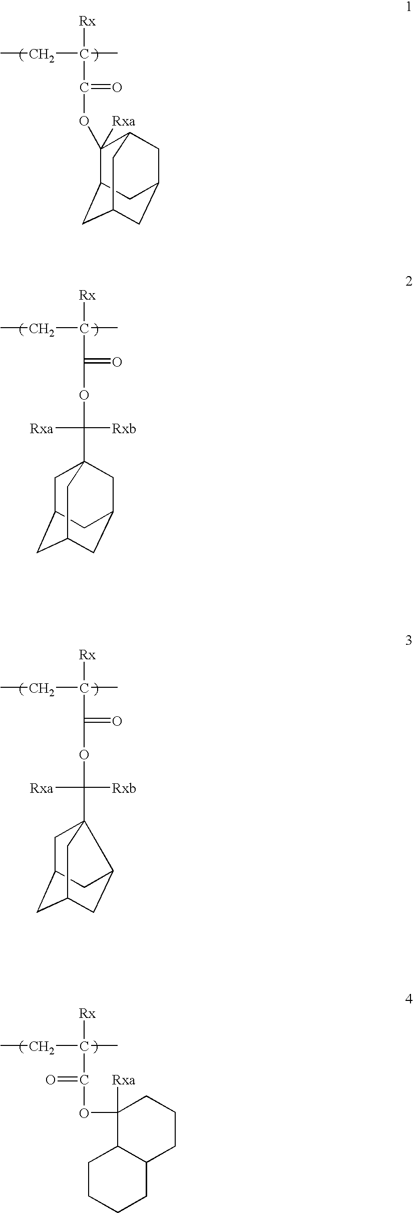

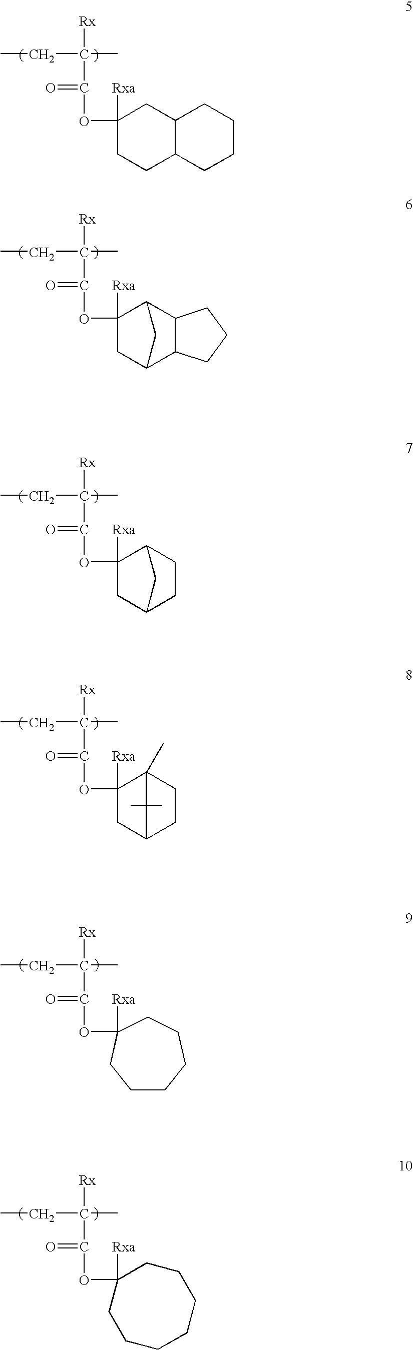

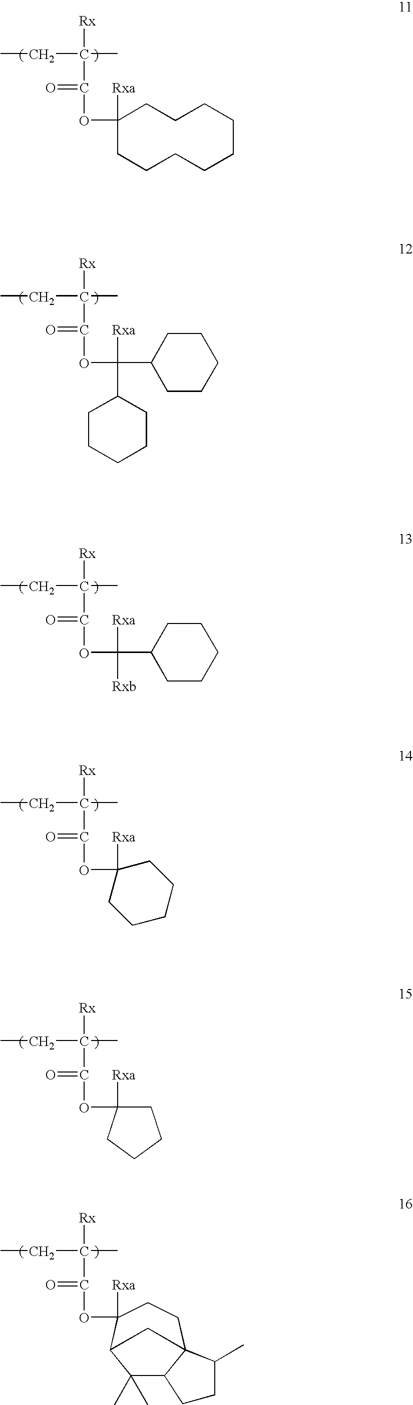

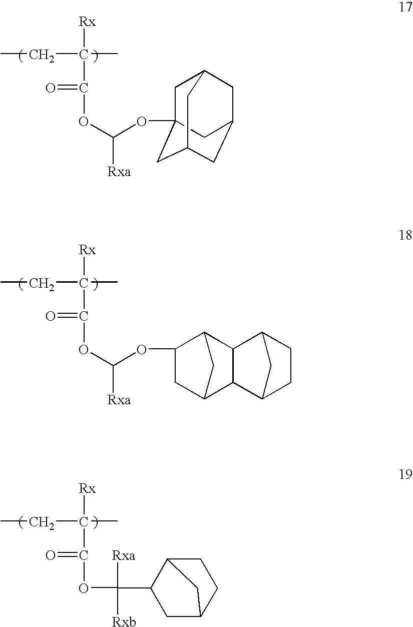

It is preferred that the resin of component (B) further contains a non-acid-decomposable repeating unit.

As the non-acid-decomposable repeating units, non-acid-decomposable repeating unit such as a repeating unit having a lactone group described later, and a repeating unit having an alicyclic hydrocarbon structure substituted with a polar group can be exemplified. “Non-acid-decomposable” here means that a positive photosensitive composition of the invention does not show reactivity to the action of an acid in generally used processes, or hardly reacts, and substantially does not have a group that contributes to image formation by the action of an acid.

It is preferred for the resin of component (B) to have a repeating unit having a lactone group. As lactone groups, any group having a lactone structure can be used, but preferably groups having 5- to 7-membered ring lactone structures, and 5- to 7-membered ring lactone structures condensed with other ring structures in the form of forming a bicyclo structure or a spiro structure are preferred. It is more preferred to have a repeating unit having a group having lactone structure represented by any of the following formulae (LC1-1) to (LC1-16). A group having a lactone structure may be directly bonded to the main chain of a polymer. It is preferred that these lactone groups are bonded to the main chain of a polymer via non-acid-decomposable bonding, i.e., a repeating unit having a lactone group is preferably a non-acid-decomposable repeating unit. The non-acid-decomposable bond is preferably a primary or secondary ester bond. A primary or secondary ester bond does not show reactivity to the action of an acid in generally used processes of a positive photosensitive composition of the invention, or hardly reacts.

Preferred lactone structures are (LC1-1), (LC1-4) (LC1-5), (LC1-6), (LC1-13) and (LC1-14). By the use of a specific lactone structure, line edge roughness and development defect are bettered.

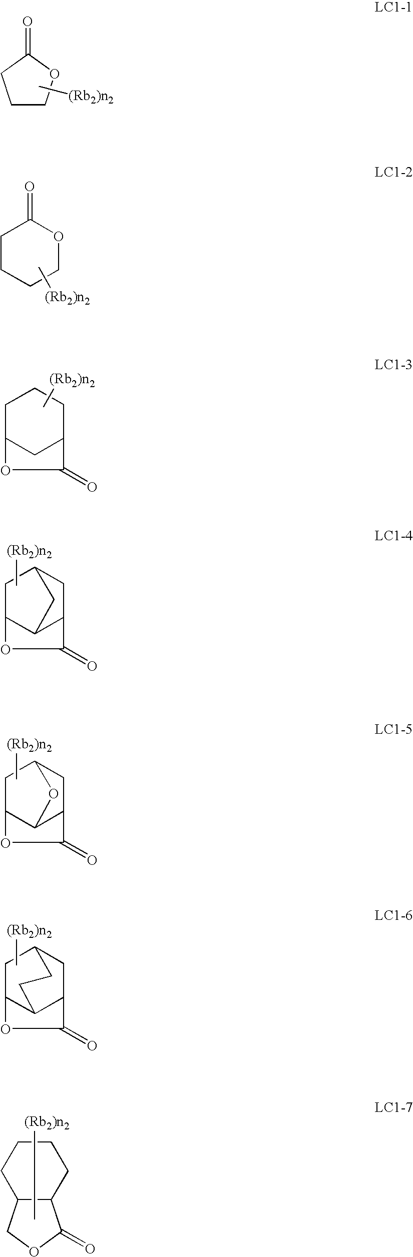

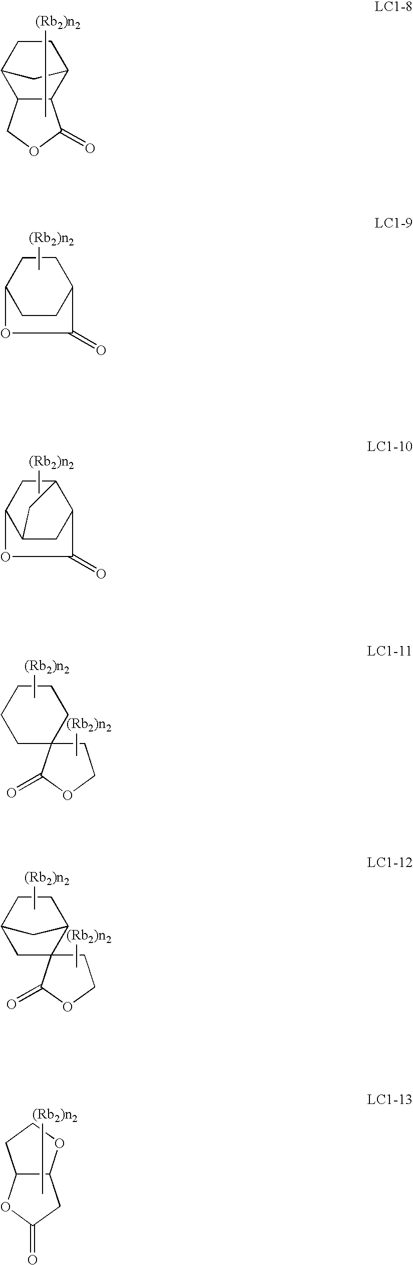

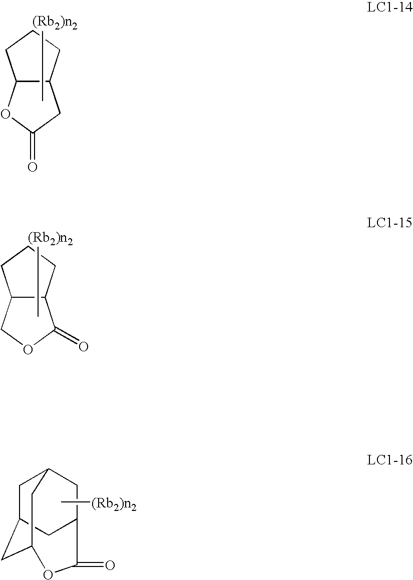

A lactone structural site may have or may not have a substituent (Rb₂). Preferred substituent (Rb₂) is an alkyl group having from 1 to 8 carbon atoms, a cycloalkyl group having from 4 to 7 carbon atoms, an alkoxyl group having from 1 to 8 carbon atoms, an alkoxycarbonyl group having from 1 to 8 carbon atoms, a carboxyl group, a halogen atom, a hydroxyl group, a cyano group, or an acid-decomposable group. n₂ represents an integer of from 0 to 4. When n₂ is 2 or more, a plurality of Rb₂ may be the same or different, and a plurality of Rb₂ may be bonded to each other to form a ring.

As repeating unit having a group having a lactone structure represented by any of formulae (LC1-1) to (LC1-16), a repeating unit represented by the following formula (AI) can be exemplified.

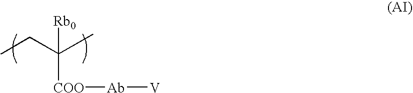

In formula (AI), Rb₀ represents a hydrogen atom, a halogen atom, or an alkyl group having from 1 to 4 carbon atoms.

As the examples of preferred substituents that the alkyl group represented by Rb₀ may have, a hydroxyl group and a halogen atom are exemplified.

As the halogen atom represented by Rb₀, a fluorine atom, a chlorine atom, a bromine atom, and an iodine atom are exemplified.

Rb₀ preferably represents a hydrogen atom or a methyl group.

Ab represents an alkylene group, a divalent linking group having a monocyclic or polycyclic alicyclic hydrocarbon structure, a single bond, an ether group, an ester group, a carbonyl group, a carboxyl group, or a divalent group of combining these groups, and preferably a single bond or a linking group represented by -Ab₁-CO₂-. Ab₁ represents a straight chain or branched alkylene group, or a monocyclic or polycyclic cycloalkylene group, and preferably amethylene group, an ethylene group, a cyclohexyl group, an adamantyl group, or a norbornyl group.

V represents a group represented by any of formulae (LC1-1) to (LC1-16).

Repeating units having a lactone structure generally have optical isomers, and any optical isomer may be used. One kind of optical isomer may be used alone, or a plurality of optical isomers may be used as mixture. When one kind of optical isomer is used, the optical purity (ee) of the optical isomer is preferably 90 or more, and more preferably 95 or more.

The specific examples of repeating units having a lactone structure are shown below, but the invention is not restricted to these compounds.
(In the formulae, Rx represents H, CH₃, CH₂OH or CF₃.) 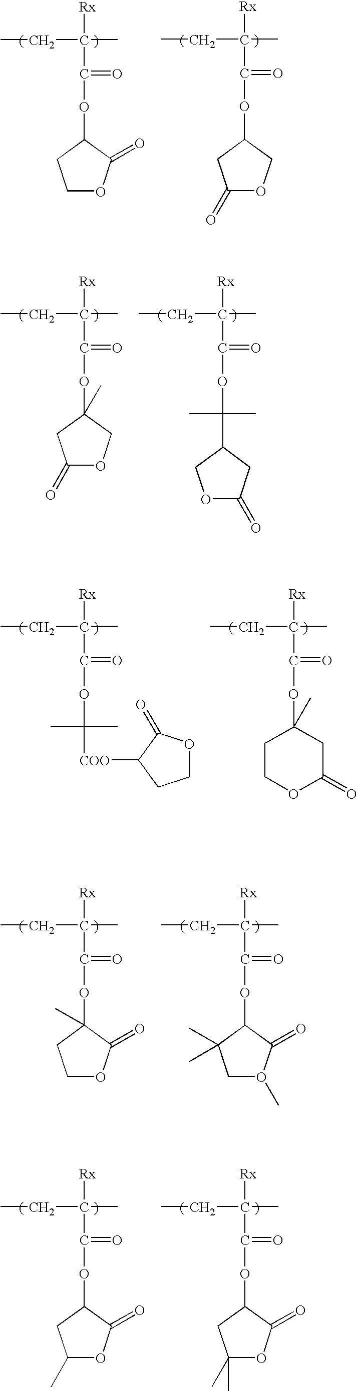 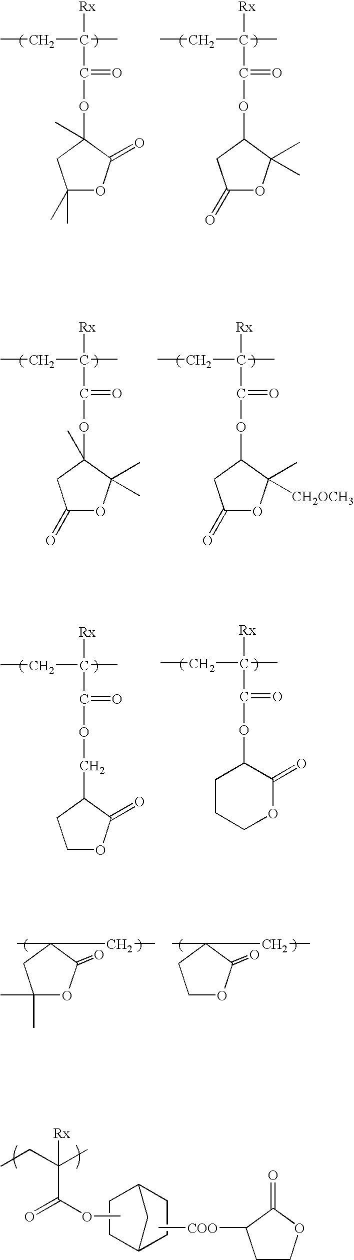 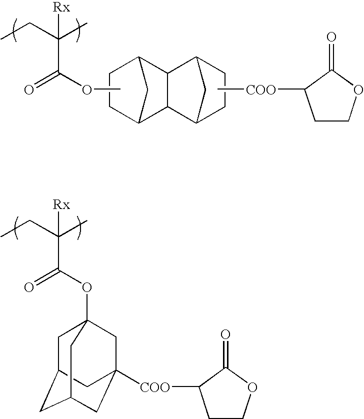
(In the formulae, Rx represents H, CH₃, CH₂OH or CF₃.) 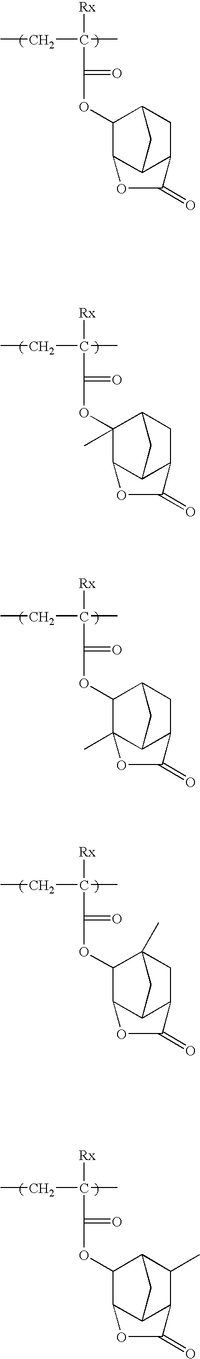 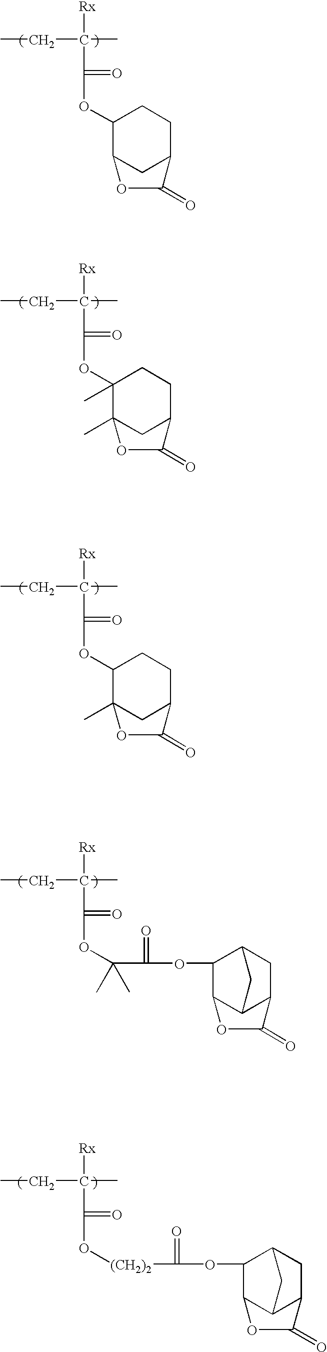 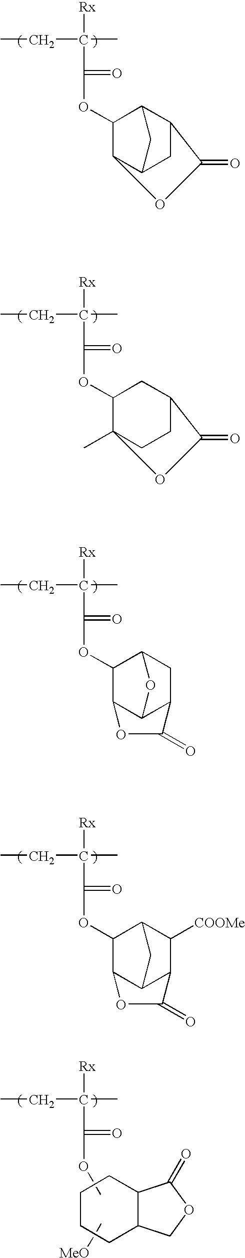 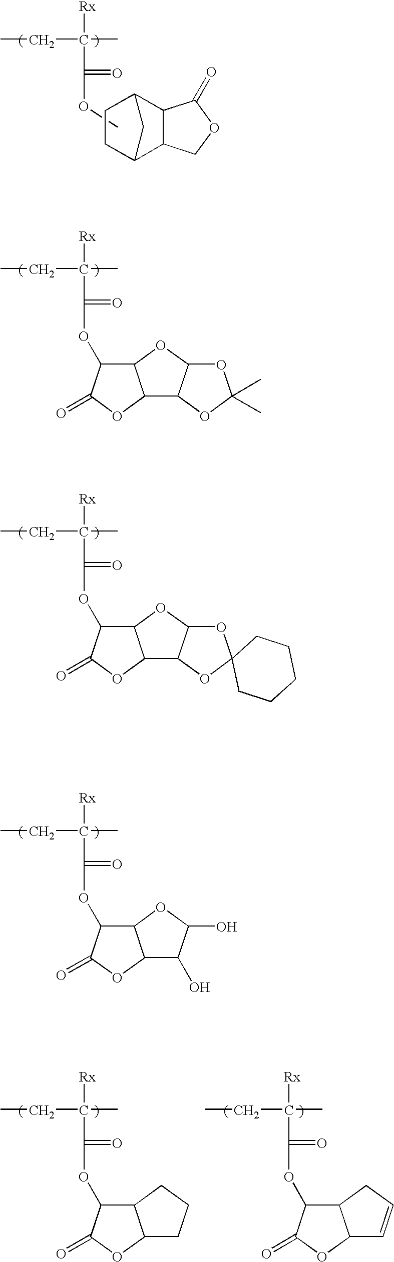 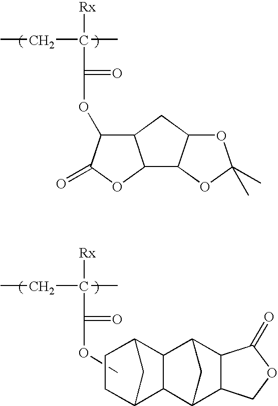
(In the formulae, Rx represents H, CH₃, CH₂OH or CF₃.)

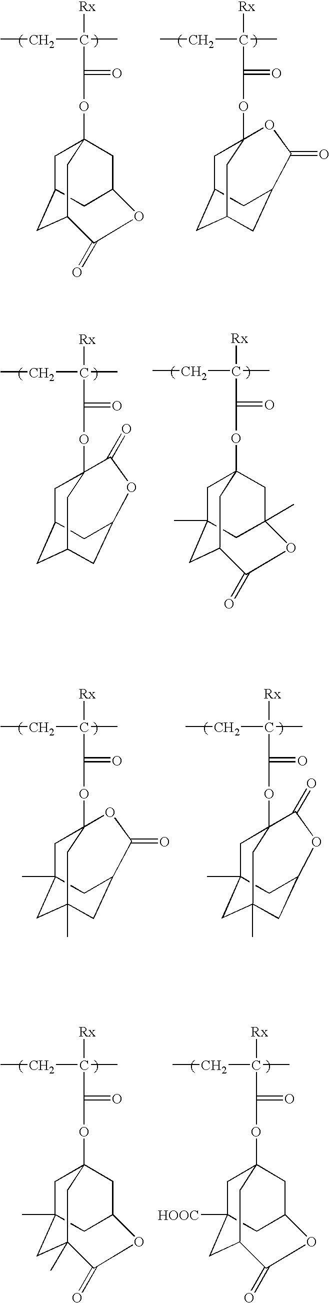

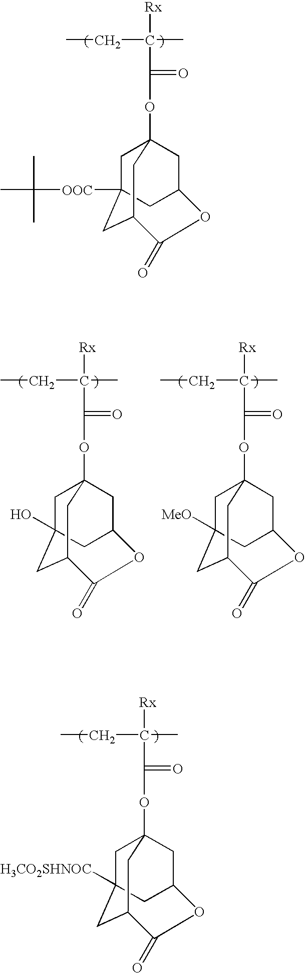

It is preferred that the resin of component (B) has a repeating unit having an alicyclic hydrocarbon structure substituted with a polar group, by which adhesion with a substrate and affinity with a developing solution are improved. The polar group is preferably a hydroxyl group or a cyano group. A repeating unit having a partial structure represented by the following formula (VIIa) or (VIIb) is preferred, and a repeating unit represented by the following formula (AIIa) or (AIIb) is more preferred.

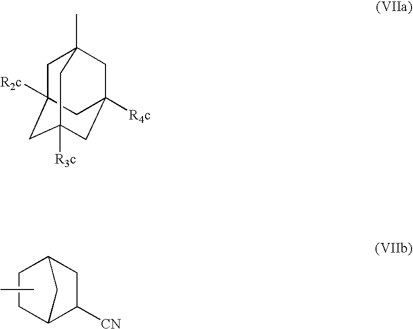

In formula (VIIa), R_{2c}, R_{3c} and R_{4c} each represents a hydrogen atom, a hydroxyl group or a cyano group, provided that at least one of R_{2c}, R_{3c} and R_{4c} represents a hydroxyl group or a cyano group. Preferably one or two of R_{2c}, R_{3c} and R_{4c} represent a hydroxyl group and the remainder represents a hydrogen atom, and more preferably two of R_{2c}, R_{3c} and R_{4c} represent a hydroxyl group and the remainder represents a hydrogen atom.

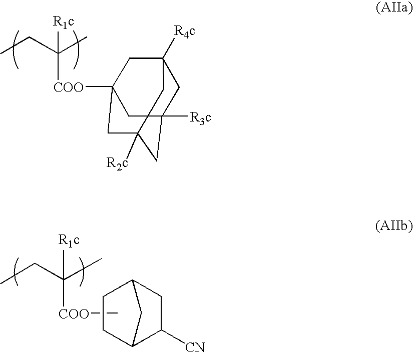

In formulae (AIIa) and (AIIb), R_{1c} represents a hydrogen atom, a methyl group, a trifluoromethyl group, or a hydroxymethyl group.

The specific examples of the repeating units having a structure represented by formula (VIIa) or (VIIb) are shown below, but the invention is not restricted thereto.

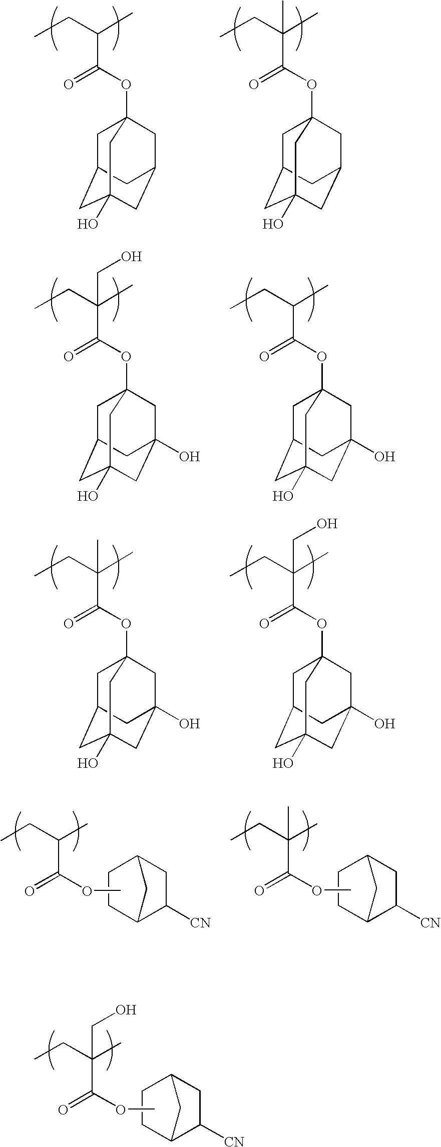

The resin of component (B) may have a repeating unit represented by the following formula (VIII).

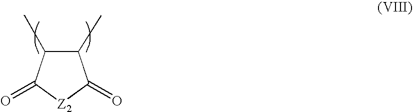

In formula (VIII), Z₂ represents —O— or —N(R₄₁)—. R₄₁ represents a hydrogen atom, a hydroxyl group, an alkyl group, or —OSO₂—R₄₂. R₄₂ represents an alkyl group, a cycloalkyl group, or a camphor residue. The alkyl group represented by R₄₁ and R₄₂ may be substituted with a halogen atom (preferably a fluorine atom) or the like.

As the specific examples of the repeating units represented by formula (VIII), the following compounds are exemplified, but the invention is not restricted thereto.

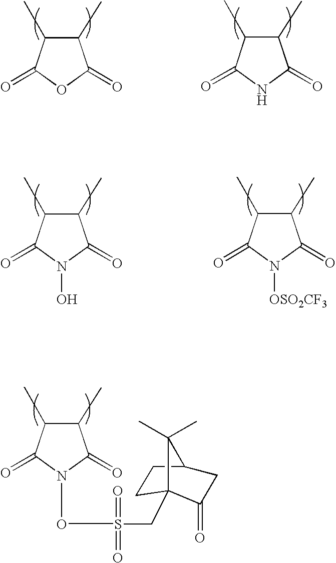

It is preferred for the resin of component (B) to have a repeating unit having an alkali-soluble group, and it is more preferred to have a repeating unit having a carboxyl group, by which the resolution in the use for contact hole is enhanced. As the repeating units having a carboxyl group, a repeating unit in which a carboxyl group is directly bonded to the main chain of a resin such as a repeating unit by acrylic acid or methacrylic acid, a repeating unit in which a carboxyl group is bonded to the main chain of a resin via a linking group, and a repeating unit in which a polymerization initiator having an alkali-soluble group and a chain transfer agent are introduced to the terminals of polymer chain by polymerization are exemplified, and these are all preferably used. The linking group may have a monocyclic or polycyclic hydrocarbon structure. Acrylic acid and methacrylic acid are most preferred.

The resin of component (B) may further have a repeating unit having from one to three groups represented by the following formula (F1), by which line edge roughness property is improved.

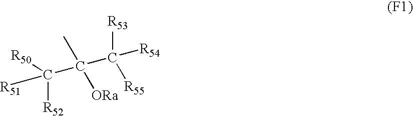

In formula (F1), R₅₀, R₅₁, R₅₂, R₅₃, R₅₄ and R₅₅ each represents a hydrogen atom, a fluorine atom, or an alkyl group, provided that at least one of R₅₀ to R₅₅ represents a fluorine atom, or an alkyl group in which at least one hydrogen atom is substituted with a fluorine atom.

Ra represents a hydrogen atom or an organic group (preferably an acid-decomposable protective group, an alkyl group, a cycloalkyl group, an acyl group, or an alkoxycarbonyl group).

The alkyl group represented by R₅₀ to R₅₅ may be substituted with a halogen atom, e.g., a fluorine atom, or a cyano group, and preferably an alkyl group having from 1 to 3 carbon atoms, e.g., a methyl group and a trifluoromethyl group can be exemplified.

It is preferred that all of R₅₀ to R₅₅ represent a fluorine atom.

The organic group represented by Ra may have an acid-decomposable protective group and a substituent, e.g., an alkyl group, a cycloalkyl group, an acyl group, an alkylcarbonyl group, an alkoxycarbonyl group, an alkoxycarbonylmethyl group, an alkoxymethyl group, and a 1-alkoxyethyl group are preferred.

The repeating unit having the group represented by formula (F1) is preferably a repeating unit represented by the following formula (F2).

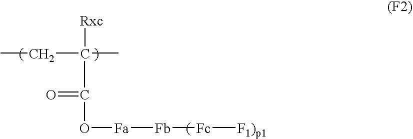

In formula (F2), Rxc represents a hydrogen atom, a halogen atom, or an alkyl group having from 1 to 4 carbon atoms. As preferred substituents that the alkyl group represented by Rxc may have, a hydroxyl group and a halogen atom are exemplified.

Fa represents a single bond or a straight chain or branched alkylene group, and preferably a single bond.

Fb represents a monocyclic or polycyclic hydrocarbon group.

Fc represents a single bond or a straight chain or branched alkylene group, and preferably a single bond or a methylene group.

F₁ represents a group represented by formula (F1).

P₁ is from 1 to 3.

As the cyclic hydrocarbon group represented by Fb, a cyclopentyl group, a cyclohexyl group, or a norbornyl group is preferred.

The specific examples of the repeating units having the structure represented by formula (F1) are shown below.

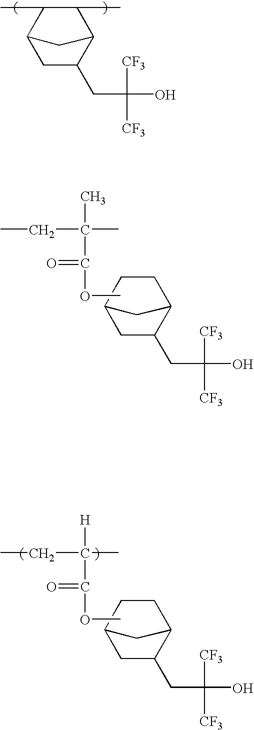

The resin of component (B) may further have a repeating unit having an alicyclic hydrocarbon structure and not showing acid decomposability, by containing such a repeating unit, the elution of low molecular weight components from a resist film into an immersion liquid can be reduced at the time of immersion exposure. As such repeating units, e.g., 1-adamantyl(meth)acrylate, tricyclodecanyl(meth)acrylate, and cyclohexyl(meth)acrylate, are exemplified.

The resin of component (B) can contain various kinds of repeating structural units, besides the above repeating structural units, for the purpose of the adjustments of dry etching resistance, aptitude for standard developing solutions, adhesion to a substrate, resist profile, and general requisite characteristics of resists, e.g., resolution, heat resistance and sensitivity.

As these repeating structural units, the repeating structural units corresponding to monomers shown below can be exemplified, but the invention is not restricted thereto.

By containing such various repeating structural units, fine adjustment of performances required of the resin of component (B), in particular the following performances, becomes possible, that is,
(1) Solubility in a coating solvent,
(2) A film-forming property (a glass transition point),
(3) Alkali developability,
(4) Decrease of layer thickness (hydrophobic-hydrophilic property, selection of an alkali-soluble group),
(5) Adhesion of an unexposed area to a substrate, and
(6) Dry etching resistance.

The examples of such monomers include compounds having one addition polymerizable unsaturated bond selected from acrylic esters, methacrylic esters, acrylamides, methacryl-amides, allyl compounds, vinyl ethers, vinyl esters, etc.

In addition to the aforementioned compounds, addition polymerizable unsaturated compounds copolymerizable with the monomers corresponding to the above various repeating structural units may be used for copolymerization.

In the resin of component (B), the molar ratio of the content of each repeating structural unit is arbitrarily set to adjust dry etching resistance, aptitude for standard developing solutions, adhesion to a substrate, and resist profile of a resist, in addition to these characteristics, general requisite characteristics of resists, e.g., resolution, heat resistance and sensitivity.

The resin of component (B) contains at least one kind of a methacrylate repeating unit and at least one kind of an acrylate repeating unit. By containing both a methacrylate repeating unit and an acrylate repeating unit, exposure latitude and PEB temperature dependency are enhanced.

A methacrylate repeating unit means a repeating unit comprising a methacrylic acid or a methacrylic acid derivative. Specifically, repeating units comprising a methacrylic acid, methacrylic esters, methacrylamides, alkylsulfonyl methacrylimides, etc., can be exemplified. For example, a repeating unit by a methacrylic acid, a repeating unit represented by formula (DPA) in which R₁ₐ represents a methyl group, a repeating unit represented by formula (DPB) in which Rx represents a methyl group, a repeating unit represented by formula (PA) in which R₁ₐ represents a methyl group, a repeating unit represented by formula (AI) in which Rb₀ represents a methyl group, a repeating unit represented by formula (AIIa) in which R_{1c} represents amethyl group, a repeating unit represented by formula (AIIb) in which R_{1c} represents a methyl group, and a repeating unit represented by formula (F2) in which Rx represents a methyl group can be exemplified.

An acrylate repeating unit means a repeating unit comprising an acrylic acid or an acrylic acid derivative. Specifically, repeating units comprising an acrylic acid, acrylic esters, acrylamides, alkylsulfonylacrylimides, etc., can be exemplified. For example, a repeating unit by an acrylic acid, a repeating unit represented by formula (DPA) in which R₁ₐ represents a hydrogen atom, a repeating unit represented by formula (DPB) in which Rx represents a hydrogen atom, a repeating unit represented by formula (PA) in which R₁ₐ represents a hydrogen atom, a repeating unit represented by formula (AI) in which Rb₀ represents a hydrogen atom, a repeating unit represented by formula (AIIa) in which R_{1c} represents a hydrogen atom, a repeating unit represented by formula (AIIb) in which R_{1c} represents a hydrogen atom, and a repeating unit represented by formula (F2) in which Rx represents a hydrogen atom can be exemplified.

In the resin of component (B), the content of a repeating unit having an acid-decomposable group is preferably in the proportion of from 10 to 60 mol % in the total repeating unit structures, more preferably from 20 to 50 mol %, and still more preferably from 25 to 40 mol %.

In the resin of component (B), the content of the repeating unit (Ba-1) is preferably from 20 to 50 mol % in the total repeating unit structures.

In the resin of component (B), the content of the repeating unit (Ba-2) is preferably from 5 to 30 mol % in the total repeating unit structures.

The ratio of methacrylate repeating unit/acrylate repeating unit is preferably from 5/95 to 95/5 in a molar ratio, more preferably from 30/70 to 95/5, still more preferably from 40/60 to 95/5, and especially preferably from 50/50 to 95/5. By making the ratio of a methacrylate repeating unit high, Tg of the resin can be maintained higher than the post heating temperature, so that exposure latitude can be bettered.

As a preferred embodiment of the resin of component (B), a resin having at least one repeating unit having a group capable of decomposing by the action of an acid to increase solubility in an alkali developer, and at least a repeating unit selected from a repeating unit having a lactone group and a repeating unit having a hydroxyl group or a cyano group can be exemplified.

When a positive photosensitive composition according to the invention is a composition for ArF exposure, it is preferred that the resin of component (B) should not contain an aromatic group from the point of the transparency to ArF ray.

As a more preferred embodiment, a ternary copolymer containing from 20 to 50 mol % of a repeating unit having an acid-decomposable group, and a diamantane structure in a group desorbed by the action of an acid of the acid-decomposable group (Ba-1), or other repeating units having an acid-decomposable group, from 20 to 50 mol % of a repeating unit having a lactone structure, and from 5 to 30 mol % of a repeating unit having a diamantane structure substituted with a polar functional group, or a repeating unit having other alicyclic hydrocarbon structure substituted with a polar group, and a quaternary copolymer further containing from 0 to 20 mol % of other repeating units are exemplified.

As another preferred embodiment, a ternary polymer containing from 5 to 30 mol % of a repeating unit having a diamantane structure and not substantially influenced by the action of an acid or an alkali (Ba-2), from 20 to 50 mol % of an acid-decomposable repeating unit having an adamantane structure, and from 20 to 50 mol % of a non-acid-decomposable repeating unit having a lactone group, and a quaternary polymer further containing from 0 to 20 mol % of other repeating units are exemplified. As the acid-decomposable repeating unit having an adamantane structure, e.g., a repeating unit represented by formula (PA) in which Rp₁ has an adamantane structure can be exemplified. As the non-acid-decomposable repeating unit having a lactone group, e.g., a repeating unit represented by formula (AI) in which V is a group not desorbed by the action of an acid can be exemplified.

It is preferred that the resin of component (B) further has a repeating unit having an adamantane structure. As the repeating unit having an adamantane structure, e.g., a repeating unit represented by formula (PA) in which Rp₁ has an adamantane structure, and a repeating represented by formula (AIIa) can be exemplified.

As preferred embodiments of the resin of component (B), resins having the following repeating units (a), (b) and (c), or a resin further having other repeating units (d) can be exemplified,
(a) from 20 to 60 mol % of a repeating unit having a group capable of decomposing by the action of an acid to increase solubility in an alkali developer,
(b) from 20 to 60 mol % of a repeating unit having a lactone group,
(c) from 5 to 30 mol % of a repeating unit having a hydroxyl group or a cyano group,
(d) from 5 to 30 mol % of other repeating units.

Of the above repeating units (a) to (d), any repeating unit may be a methacrylate repeating unit or an acrylate repeating unit, but preferably a repeating unit (b) or (c) is an acrylate repeating unit. By using an acrylate repeating unit as an appropriate repeating unit, well balanced exposure latitude and PEB temperature dependency can be improved.

The resin of component (B) can be synthesized according to ordinary methods (e.g., radical polymerization). For example, as ordinary methods, a batch polymerization method of performing polymerization by dissolving a monomer seed and a polymerization initiator in a solvent and heating, and a dropping polymerization method of adding a solution of a monomer seed and a polymerization initiator into a heated solvent by dropping over 1 to 10 hours are exemplified, and a dropping polymerization method is preferred. As the addition method of a monomer in the dropping polymerization method, there are a method of putting a solvent alone into a reaction vessel and adding a monomer solution to the above solution by dropping, and a method of putting a part of a monomer seed into a reaction vessel in advance, and adding the remainder by dropping, and either method can be used. Further, a polymerization initiator may be added as the same solution with a monomer, or may be added as different solution from a monomer solution. When a polymerization initiator is added as different solution from a monomer solution, the dropping speed of the monomer solution and that of the polymerization solution may be the same or different. As the reaction solvents, ethers, e.g., tetrahydrofuran, 1,4-dioxane, and diisopropyl ether, ketones, e.g., methyl ethyl ketone and methyl isobutyl ketone, an ester solvent, e.g., ethyl acetate, an amide solvent, e.g., dimethylformamide and dimethylacetamide, and the solvents capable of dissolving a positive photosensitive composition of the invention described later, e.g., propyelne glycol monomethyl ether acetate, propyelne glycol monomethyl ether, and cyclohexanone are exemplified. It is more preferred to use the same solvent as used in a positive photosensitive composition in the invention in polymerization, by which the generation of particles during preservation can be restrained.

It is preferred to perform polymerization reaction in the atmosphere of inert gas such as nitrogen or argon. Polymerization is initiated with commercially available radical polymerization initiators (e.g., azo initiators, peroxide and the like). As radical polymerization initiators, azo initiators are preferred, and azo initiators having an ester group, a cyano group, or a carboxyl group are preferred. As preferred initiators, azobisisobutyronitrile, azobis-dimethylvaleronitrile, dimethyl-2,2′-azibis(2-methyl-propionate), etc., are exemplified. Initiators are added additionally or dividedly, if desired, and after termination of reaction, the reaction product is put into a solvent and an objective polymer is recovered as powder or a solid state. The reaction concentration is from 5 to 50 mass %, and preferably from 10 to 30 mass %. The reaction temperature is generally from 10 to 150° C., preferably from 30 to 120° C., and more preferably from 60 to 100° C.

The weight average molecular weight of the resin of component (B) is preferably from 3,000 to 30,000 as the polystyrene equivalent by the GPC method, more preferably from 5,000 to 15,000, and still more preferably from 6,000 to 12,000.

The weight average molecular weight can be adjusted by properly selecting the kind and amount of polymerization initiator, a chain transfer agent, polymerization temperature, a reaction solvent, and reaction concentration in the polymerization reaction, and polymerization method (dropping polymerization or en bloc polymerization).

The degree of dispersion (Mw/Mn) of the resin of component (B) is preferably from 1.1 to 3.0, more preferably from 1.2 to 2.5, and still more preferably from 1.4 to 2.1.

For adjusting degree of dispersion, e.g., a resin having degree of dispersion of from 1.0 to 1.5 can be obtained with a living radical polymerization method. Incidentally, a resin having narrow degree of dispersion can be obtained from a resin having relatively broad degree of dispersion obtained by polymerization by eliminating a low molecular weight component, or a high molecular weight component, or both, by making use of the difference in solubility of the resin in a solvent by reprecipitation or washing with a solvent.

In a positive photosensitive composition in the invention, the blending amount of the resin of component (B) is preferably in the proportion of from 50 to 99.99 mass % in all the composition, and more preferably from 60 to 99.0 mass %.

In the invention, the resin of component (B) can be used one kind alone, or a plurality of resins may be used in combination.

(B2) A Resin Not Having a Group Capable of Decomposing by the Action of an Acid:

A positive photosensitive composition of the invention may contain a resin not having a group capable of decomposing by the action of an acid (hereinafter also referred to as “the resin of component (B2)”).

The terminology “not having a group capable of decomposing by the action of an acid” means that a positive photosensitive composition of the invention does not show reactivity to the action of an acid in generally used image forming process, or hardly reacts, and does not substantially have a group that contributes to image formation by acid decomposition. As such a resin, a resin having an alkali-soluble group, and a resin having a group capable of decomposing by the action of an alkali to increase solubility in an alkali developer are exemplified.

As the resin of component (B2), e.g., a resin having at least one kind of repeating unit derived from (meth)acrylic acid derivatives and/or alicyclic olefin derivatives is preferred.

As alkali-soluble groups in the resin of component (B2), e.g., a carboxyl group, a phenolic hydroxyl group, an aliphatic hydroxyl group substituted with an electron attrative group on the 1- or 2-pposition, an aino group substituted with an electron attractive group (e.g., a sulfonamido group, a sulfonimido group, and a bissulfonylimido group), and a methylene group or a methine group substituted with an electron attractive group (e.g., a methylene group or a methine group substituted with at least two groups selected from a ketone group and an ester group) are preferred.

As the group capable of decomposing by the action of an alkali to increase solubility in an alkali developer in the resin of component (B2), e.g., a lactone group and an acid anhydride group are preferred, and a lactone group is more preferred.

The resin of component (B2) may further have a repeating unit having functional groups besides the above. The repeating unit having other functional groups can be selected from repeating units having proper functional groups considering dry etching resistance, hydrophilic/hydrophobic property, mutual action, and the like.

As the repeating unit having other functional groups, e.g., a repeating unit having functional groups such as a hydroxyl group, a cyano group, a carbonyl group or an ester group, a repeating unit having a monocyclic or polycyclic hydrocarbon structure, a repeating unit having a fluoroalkyl group, and a repeating unit having two or more these functional groups can be exemplified.

The weight average molecular weight of the resin of component (B2) is preferably from 3,000 to 30,000 as the polystyrene equivalent by the GPC method, more preferably from 5,000 to 15,000, and still more preferably from 6,000 to 12,000.

The preferred specific examples of the resins of component (B2) are shown below, but the invention is not restricted thereto.

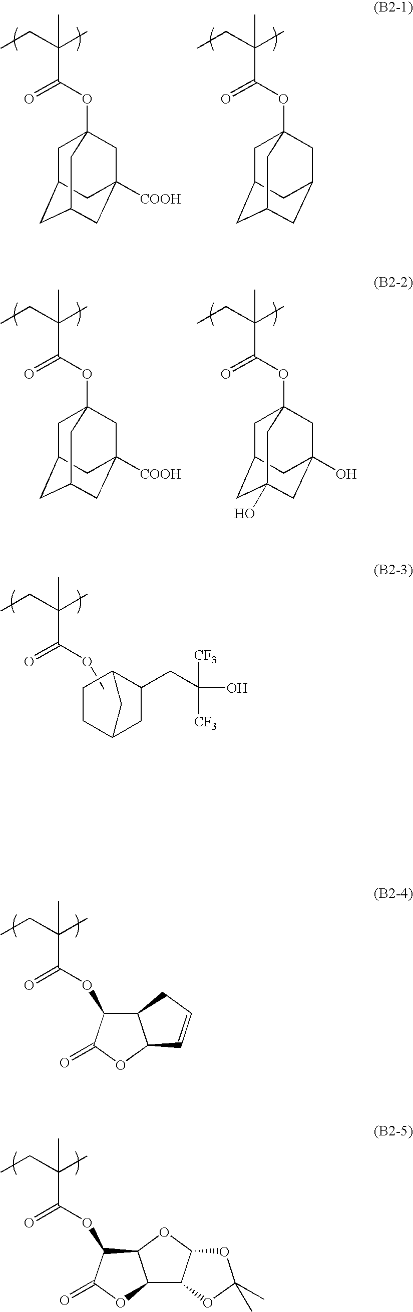

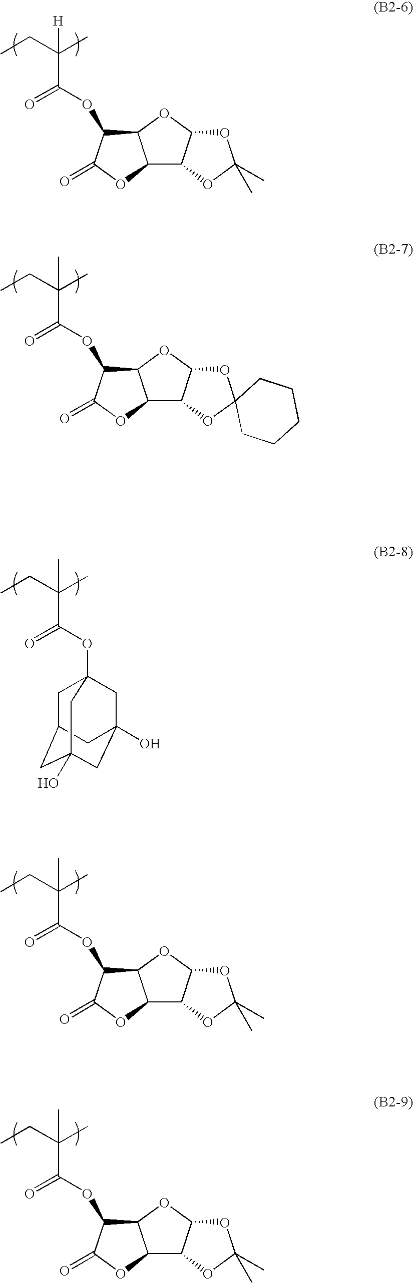

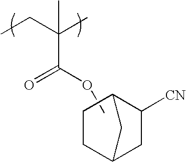

The addition amount of the resin of component (B2) is generally in the proportion of from 0 to 50 mass % of the resin of component (B), preferably from 0 to 30 mass %, and still more preferably from 0 to 20 mass %.

[3] (C) A Dissolution Inhibiting Compound Having a Molecular Weight of 3,000 or Less Capable of Decomposing by the Action of an Acid to Increase the Solubility in an Alkali Developer:

A positive photosensitive composition in the invention can contain a compound having a molecular weight of 3,000 or less that is capable of decomposing by the action of an acid to increase the solubility in an alkali developer (hereinafter also referred to as “a dissolution inhibiting compound”).

As the dissolution inhibiting compound, so as not to reduce transmission of 220 nm or less, alicyclic or aliphatic compounds containing an acid-decomposable group, such as cholic acid derivatives containing an acid-decomposable group as described in Proceeding of SPIE, 2724, 355 (1996) are preferred. As the acid-decomposable groups and alicyclic structures, the same as those described in the resin of component (B) can be exemplified.

The molecular weight of the dissolution inhibiting compound is 3,000 or less, preferably from 300 to 3,000, and more preferably from 500 to 2,500.

The addition amount of the dissolution inhibiting compound is preferably in the proportion of from 3 to 50 mass % based on the solids content of the positive photosensitive composition, and more preferably from 5 to 40 mass %.

The specific examples of dissolution inhibiting compounds are shown below, but the invention is not restricted to these compounds. 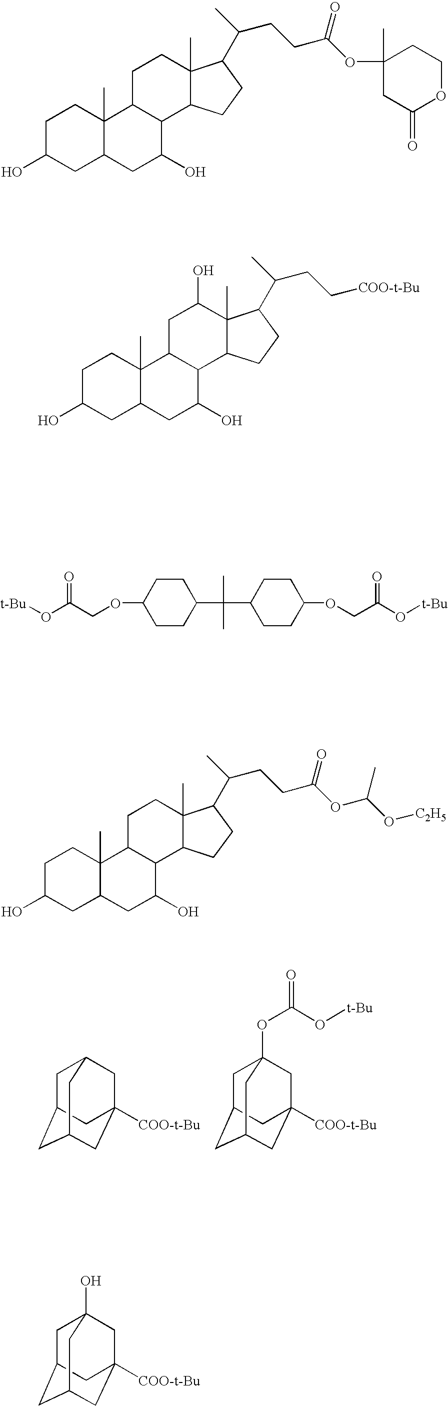
[4] (D) A Basic Compound:

For reducing the fluctuation of performances due to aging from exposure to heating, or restraining the diffusibility of an acid generated by exposure into the film, it is preferred for a positive photosensitive composition of the invention to contain a basic compound.

As basic compounds, nitrogen-containing basic compounds and onium salt compounds can be exemplified.

As preferred nitrogen-containing basic compounds, compounds having a partial structure represented be any of the following formulae (A) to (E) can be exemplified.

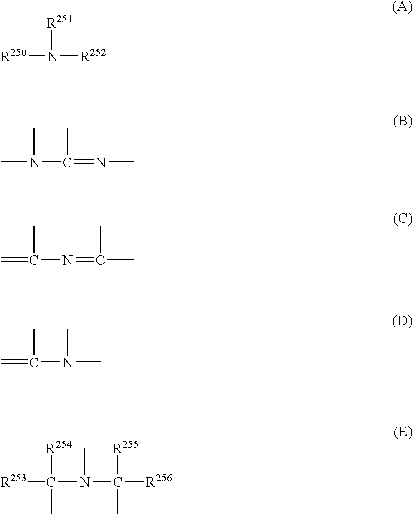

In formula (A), R²⁵⁰, R²⁵¹ and R²⁵² each represents a hydrogen atom, an alkyl group having from 1 to 20 carbon atoms, a cycloalkyl group having from 3 to 20 carbon atoms, or an aryl group having from 6 to 20 carbon atoms, and R²⁵⁰ and R²⁵¹ may be bonded to each other to form a ring. These groups may have a substituent, and as the alkyl group and the cycloalkyl group having a substituent, an aminoalkyl group having from 1 to 20 carbon atoms, an aminocycloalkyl group having from 3 to 20 carbon atoms, a hydroxyalkyl group having from 1 to 20 carbon atoms, and a hydroxycycloalkyl group having from 3 to 20 carbon atoms are preferred. These groups may contain an oxygen atom, a sulfur atom or a nitrogen atom in the alkyl chain.

In formula (E), R²⁵³, R²⁵⁴, R²⁵⁵ and R²⁵⁶ each represents an alkyl group having from 1 to 6 carbon atoms, or a cycloalkyl group having from 3 to 6 carbon atoms.

As preferred examples of basic compounds, guanidine, aminopyrrolidine, pyrazole, pyrazoline, piperazine, aminomorpholine, aminoalkylmorpholine, and piperidine can be exemplified, and these compounds may have a substituent. As further preferred compounds, compounds having an imidazole structure, a diazabicyclo structure, an onium hydroxide structure, an onium carboxylate structure, a trialkylamine structure, an aniline structure, or a pyridine structure, alkylamine derivatives having a hydroxyl group and/or an ether bond, aniline derivatives having a hydroxyl group and/or an ether bond, etc., can be exemplified.

As the compound having an imidazole structure, 2,4,5-triphenylimidazole and benzimidazole can be exemplified. As the compounds having a diazabicyclo structure, 1,4-diazabicyclo[2,2,2]octane, 1,5-diazabicyclo[4,3,0]nona-5-ene, and 1,8-diazabicyclo[5,4,0]undeca-7-ene can be exemplified. As the compounds having an onium hydroxide structure, triaryl-sulfonium hydroxide, phenacylsulfonium hydroxide, sulfonium hydroxide having a 2-oxoalkyl group, specifically triphenyl-sulfonium hydroxide, tris(t-butylphenyl)sulfonium hydroxide, bis(t-butylphenyl)iodonium hydroxide, phenacylthiophenium hydroxide, and 2-oxopropylthiophenium hydroxide can be exemplified. The compounds having an onium carboxylate structure are compounds having an onium hydroxide structure in which the anionic part is carboxylated, e.g., acetate, adamantane-1-carboxylate and perfluoroalkyl carboxylate are exemplified. As the compounds having a trialkylamine structure, tri(n-butyl)amine and tri(n-octyl)amine are exemplified. As the aniline compounds, 2,6-diisopropyl-aniline and N,N-dimethylaniline are exemplified. As the alkylamine derivatives having a hydroxyl group and/or an ether bond, ethanolamine, diethanolamine, triethanolamine, and tris(methoxyethoxyethyl)amine are exemplified. As the aniline derivatives having a hydroxyl group and/or an ether bond, N,N-bis(hydroxyethyl)aniline is exemplified.

These basic compounds are used alone or in combination of two or more. The use amount of basic compounds is generally from 0.001 to 10 mass % based on the solids content of the positive photosensitive composition, and preferably from 0.01 to 5 mass %. For obtaining a sufficient addition effect, the addition amount is preferably 0.001 mass % or more, and in view of sensitivity and the developability of a non-exposed area, it is preferably 10 mass % or less.

[5] (E) Surfactant:

It is preferred for the positive photosensitive composition in the invention to further contain a surfactant, and it is more preferred to contain either one or two or more of fluorine and/or silicon surfactants (a fluorine surfactant, a silicon surfactant, a surfactant containing both a fluorine atom and a silicon atom)

By containing fluorine and/or silicon surfactants, it becomes possible for the positive photosensitive composition in the invention to provide a resist pattern excellent in sensitivity and resolution, and low in defects in adhesion and development in using an exposure light source of 250 nm or lower, in particular, 220 nm or lower.

These fluorine and/or silicon surfactants are disclosed, e.g., in JP-A-62-36663, JP-A-61-226746, JP-A-61-226745, JP-A-62-170950, JP-A-63-34540, JP-A-7-230165, JP-A-8-62834, JP-A-9-54432, JP-A-9-5988, JP-A-2002-277862, U.S. Pat. Nos. 5,405,720, 5,360,692, 5,529,881, 5,296,330, 5,436,098, 5,576,143, 5,294,511 and 5,824,451. The commercially available surfactants shown below can also be used as they are.

As the commercially available fluorine or silicon surfactants usable in the invention, Eftop EF301 and EF303 (manufactured by Shin-Akita Kasei Co., Ltd.), Fluorad FC 430 and 431 (manufactured by Sumitomo 3M Limited), Megafac F171, F173, F176, F189 and R08 (manufactured by Dainippon Ink and Chemicals Inc.), Sarfron S-382, SC 101, 102, 103, 104, 105 and 106 (manufactured by ASAHI GLASS CO., LTD.), and Troy Sol S-366 (manufactured by Troy Chemical Co., Ltd.) are exemplified. In addition, polysiloxane polymer KP-341 (manufactured by Shin-Etsu Chemical Co., Ltd.) can also be used as a silicon surfactant.

In addition to these known surfactants as exemplified above, surfactants using polymers having fluoro-aliphatic groups derived from fluoro-aliphatic compounds manufactured by a telomerization method (also called a telomer method) or an oligomerization method (also called an oligomer method) can be used. Fluoro-aliphatic compounds can be synthesized by the method disclosed in JP-A-2002-90991.

As polymers having fluoro-aliphatic groups, copolymers of monomers having fluoro-aliphatic groups and (poly(oxy-alkylene)) acrylate and/or (poly(oxyalkylene)) methacrylate are preferred, and they may be distributed at random or may be block copolymerized. As the poly(oxyalkylene) groups, a poly(oxyethylene) group, a poly(oxypropylene) group, and a poly(oxybutylene) group are exemplified. Further, the polymers may be units having alkylenes different in chain length in the same chain length, such as a block combination of poly (oxyethylene and oxypropylene and oxyethylene), and a block combination of poly(oxyethylene and oxypropylene). In addition, copolymers of monomers having fluoro-aliphatic groups and poly(oxyalkylene) acrylate (or methacrylate) may be not only bipolymers but also terpolymers or higher polymers obtained by copolymerization of monomers having different two or more kinds of fluoro-aliphatic groups or different two or more kinds of poly(oxyalkylene) acrylates (or methacrylates) at the same time.

For example, as commercially available surfactants, Megafac F178, F470, F473, F475, F476 and F472 (manufactured by Dainippon Ink and Chemicals Inc.) can be exemplified. Further, copolymers of acrylate (or methacrylate) having a C₆F₁₃ group and (poly(oxyalkylene)) acrylate (or methacrylate), copolymers of acrylate (or methacrylate) having a C₆F₁₃ group, (poly(oxyethylene)) acrylate (or methacrylate), and (poly(oxypropylene)) acrylate (or methacrylate), copolymers of acrylate (or methacrylate) having a CsF₁₇ group and (poly(oxyethylene)) acrylate (or methacrylate), copolymers of acrylate (or methacrylate) having a C₈F₁₇ group, (poly(oxy-ethylene)) acrylate (or methacrylate), and poly(oxypropylene) acrylate (or methacrylate) are exemplified.

In the invention, surfactants other than the above fluorine and/or silicon surfactants can also be used. Specifically, nonionic surfactants, such as polyoxyethylene alkyl ethers, polyoxyethylene alkylaryl ethers, polyoxyethylene/polyoxypropylene block copolymers, sorbitan fatty acid esters, polyoxyethylene sorbitan fatty acid esters, etc., can be used.

The use amount of surfactants is preferably from 0.0001 to 2 mass % to the total amount of the positive photosensitive composition (excluding solvents), and more preferably from 0.001 to 1 mass %.

[6] (F) A Solvent:

For using a positive photosensitive composition in the invention, the above components are dissolved in a prescribed solvent.

As the solvents usable in the invention, organic solvents such as ethylene dichloride, cyclohexanone, cyclopentanone, 2-heptanone, γ-butyrolactone, methyl ethyl ketone, ethylene glycol monomethyl ether, ethylene glycol monoethyl ether, 2-methoxyethyl acetate, ethylene glycol monoethyl ether acetate, propylene glycol monomethyl ether, propylene glycol monomethyl ether acetate, toluene, ethyl acetate, methyl lactate, ethyl lactate, methyl methoxypropionate, ethyl ethoxypropionate, methyl pyruvate, ethyl pyruvate, propyl pyruvate, N,N-dimethylformamide, dimethyl sulfoxide, N-methylpyrrolidone, tetrahydrofuran, etc., are exemplified.

In the invention, solvents may be used alone or as mixture, but it is preferred to use mixed solvents containing two or more kinds of solvents having different functional groups. By the use of such a mixed solvent, not only the solubility of materials is heightened and the generation of particles by aging can be restrained, but also a good pattern profile can be obtained. As the preferred functional groups for solvents, an ester group, a lactone group, a hydroxyl group, a ketone group, and a carbonate group are exemplified. As the mixed solvents having different functional groups, the following mixed solvents (S1) to (S5) are preferred.
(S1) Mixed solvent mixed of a solvent having a hydroxyl group and a solvent not having a hydroxyl group
(S2) Mixed solvent mixed of a solvent having an ester structure and a solvent having a ketone structure
(S3) Mixed solvent mixed of a solvent having an ester structure and a solvent having a lactone structure
(S4) Mixed solvent mixed of a solvent having an ester structure, a solvent having a lactone structure, and a solvent having a hydroxyl group
(S5) Mixed solvent mixed of a solvent having an ester structure, a solvent having a carbonate structure, and a solvent having a hydroxyl group

By the use of these mixed solvents, the generation of particles during preservation of a resist solution can be reduced and the generation of coating defects can be restrained.

As the solvents having a hydroxyl group, e.g., ethylene glycol, ethylene glycol monomethyl ether, ethylene glycol monoethyl ether, propylene glycol, propylene glycol monomethyl ether, propylene glycol monoethyl ether, ethyl lactate, etc., are preferred, and of these solvents, propylene glycol monomethyl ether and ethyl lactate are preferred.

As the solvents not having a hydroxyl group, e.g., propylene glycol monomethyl ether acetate, ethylethoxy-propionate, 2-heptanone, γ-butyrolactone, cyclohexanone, butyl acetate, N-methylpyrrolidone, N,N-dimethylacetamide, dimethyl sulfoxide, etc., can be exemplified, and of these solvents, propylene glycol monomethyl ether acetate, ethylethoxypropionate, 2-heptanone, γ-butyrolactone, cyclohexanone, butyl acetate are preferred, and propylene glycol monomethyl ether acetate, ethylethoxypropionate, 2-heptanone, and cyclohexanone are more preferred.

As the solvents having a ketone structure, cyclohexanone, 2-heptanone, etc., are exemplified, and cyclohexanone is preferred.

As the solvents having an ester structure, propylene glycol monomethyl ether acetate, ethylethoxypropionate, butyl acetate, etc., are exemplified, and propylene glycol monomethyl ether acetate is preferred.

As the solvent having a lactone structure, γ-butyrolactone is exemplified.

As the solvents having a carbonate structure, propylene carbonate and ethylene carbonate are exemplified, and propylene carbonate is preferred.

The mixing ratio (by mass) of the solvent having a hydroxyl group and the solvent not having a hydroxyl group is from 1/99 to 99/1, preferably from 10/90 to 90/10, and more preferably from 20/80 to 60/40. Mixed solvents containing in the proportion of 50 mass % or more of the solvents not having a hydroxyl group are especially preferred for capable of obtaining coating uniformity.

The mixing ratio (by mass) of the solvent having an ester structure and the solvent having a ketone structure is from 1/99 to 99/1, preferably from 10/90 to 90/10, and more preferably from 40/60 to 80/20. Mixed solvents containing in the proportion of 50 mass % or more of the solvents having an ester structure are especially preferred for capable of obtaining coating uniformity.

The mixing ratio (by mass) of the solvent having an ester structure and the solvent having a lactone structure is from 70/30 to 99/1, preferably from 80/20 to 99/1, and more preferably from 90/10 to 99/1. Mixed solvents containing in the proportion of 70 mass % or more of the solvents having an ester structure are especially preferred in the light of aging stability.

When the solvent having an ester structure, the solvent having a lactone structure and the solvent having a hydroxyl group are mixed, it is preferred to mix in proportion of from 30 to 80 wt % of the solvent having an ester structure, from 1 to 20 wt % of the solvent having a lactone structure, and from 10 to 60 wt % of the solvent having a hydroxyl group.

When the solvent having an ester structure, the solvent having a carbonate structure and the solvent having a hydroxyl group are mixed, it is preferred to mix in proportion of from 30 to 80 wt % of the solvent having an ester structure, from 1 to 20 wt % of the solvent having a carbonate structure, and from 10 to 60 wt % of the solvent having a hydroxyl group.

As more preferred embodiments, solvents containing alkylene glycol monoalkyl ether carboxylate (preferably propylene glycol monomethyl ether acetate) are preferred, mixed solvents of alkylene glycol monoalkyl ether carboxylate and other solvents are more preferred, and it is still more preferred that other solvent is at least a solvent selected from the solvents having a functional group, e.g., a hydroxyl group, a ketone group, a lactonegroup, an estergroup, anethergroup, oracarbonategroup, or a plurality of these functional groups. Especially preferred solvents are mixed solvents of at least one solvent selected from among ethyl lactate, γ-butyrolactone, propylene glycol monomethyl ether, butyl acetate, and cyclohexanone, with propylene glycol monomethyl ether acetate. By selecting especially preferred solvents, the performance of development defects can be improved.

The mixing ratio (by mass) of alkylene glycol monoalkyl ether carboxylate and other solvent is alkylene glycol monoalkyl ether carboxylate/other solvent of preferably from 95/5 to 30/70, more preferably from 95/5 to 40/60, and still more preferably from 80/20 to 50/50. By making the proportion of alkylene glycol monoalkyl ether carboxylate high, the change of properties of a positive photosensitive composition by aging from coating to exposure can be made small.

The solid concentration of a positive photosensitive composition of the invention is preferably from 3 to 15 mass %, more preferably from 4 to 10 mass %, and still more preferably from 5 to 8 mass %.

Other Additives:

If necessary, a positive photosensitive composition of the invention can further contain dyes, plasticizers, photosensitizers, and compounds for accelerating solubility in a developing solution.

Compounds for accelerating solubility in a developing solution usable in the invention are low molecular weight compounds having two or more phenolic OH groups or one or more carboxyl groups and a molecular weight of 1,000 or less. When the solubility accelerating compounds have carboxyl groups, alicyclic or aliphatic compounds are preferred.

A preferred addition amount of these dissolution accelerating compounds is preferably in the proportion of from 2 to 50 mass % based on the resin of component (B), and more preferably from 5 to 30 mass %. The amount is preferably 50 mass % or less in the point of restraint of development residue and prevention of pattern deformation at development.

These phenolic compounds having a molecular weight of 1,000 or less can be easily synthesized with referring to the methods disclosed, e.g., in JP-A-4-122938, JP-A-2-28531, U.S. Pat. No. 4,916,210, and EP 219294.

As the specific examples of the alicyclic or aliphatic compounds having a carboxyl group, carboxylic acid derivatives having a steroid structure, e.g., cholic acid, deoxycholic acid, and lithocholic acid, adamantanecarboxylic acid derivatives, adamantanedicarboxylic acid, cyclohexanecarboxylic acid, and cyclohexanedicarboxylic acid are exemplified, but the invention is by no means restricted to these compounds.

Pattern-Forming Method:

A positive photosensitive composition in the invention is used by dissolving the above components in a prescribed solvent, preferably dissolving in the mixed solvent as described above, filtering, and coating the solution on a prescribed support as follows. The filter for use in filtration is preferably made of polytetrafluoroethylene, polyethylene or nylon having a pore diameter of 0.1 μm or less, more preferably 0.05 μm or less, and more preferably 0.03 μm or less.

For example, a positive photosensitive composition is coated on a substrate such as the one used in the manufacture of fine integrated circuit element (e.g., silicon/silicon dioxide coating) by an appropriate coating method with a spinner or a coater, and dried, to thereby form a photosensitive film.

The thickness of the photosensitive film formed is preferably from 50 to 300 nm, more preferably from 70 to 200 nm, and still more preferably from 80 to 150 nm. The thinner the film thickness, the more conspicuous is the effect of a positive photosensitive composition.

The photosensitive film is irradiated with actinic ray or radiation through a prescribed mask, preferably subjected to baking (heating), and then development and rinsing. Thus, a good pattern can be obtained.

At the time of irradiation with actinic ray or radiation, exposure (immersion exposure) may be performed by filling a liquid (an immersion medium) having higher refractive index than that of air between a photosensitive film and a lens, by which resolution can be raised. As the immersion medium, any liquids can be used so long as they are liquids higher in refractive index than air, but pure water is preferred. An overcoat layer may be further provided on a photosensitive film so that an immersion medium and the photosensitive film are not directly touched in performing immersion exposure, by which the elution of the photosensitive composition from the photosensitive film to the immersion medium is restrained and development defect can be reduced.

As actinic rays or radiation, infrared rays, visible rays, ultraviolet rays, far ultraviolet rays, X-rays and electron beams can be exemplified, and preferably far ultraviolet rays of wavelengths of 250 nm or less, and more preferably 220 nm or less. Specifically, a KrF excimer laser (248 nm), an ArF excimer laser (193 nm), an F₂ excimer laser (157 nm), X-rays and electron beams are exemplified, and ArF excimer lasers, F₂ excimer lasers, EUV (13 nm), and electron beams are preferred.

In a development process, an alkali developer is used as follows. As the alkali developer of the resist composition, alkaline aqueous solutions of inorganic alkalis, e.g., sodium hydroxide, potassium hydroxide, sodium carbonate, sodium silicate, sodium metasilicate and aqueous ammonia, primary amines, e.g., ethylamine and n-propylamine, secondary amines, e.g., diethylamine and di-n-butylamine, tertiary amines, e.g., triethylamine and methyldiethylamine, alcohol amines, e.g., dimethylethanolamine and triethanol-amine, quaternary ammonium salts, e.g., tetramethylammonium hydroxide and tetraethylammonium hydroxide, and cyclic amines, e.g., pyrrole and piperidine, can be used.

An appropriate amount of alcohols and surfactants may be added to these alkali developers.

The alkali concentration of the alkali developers is generally from 0.1 to 20 mass %.

The pH of the alkali developers is generally from 10.0 to 15.0.

### EXAMPLE

The invention will be described with reference to examples, but the invention is not restricted thereto.

### Synthesis Example 1

### Synthesis of Monomer (A)

Hydroxydiamantane (9.8 g), 3.7 g of methacrylic anhydride, and 0.5 g of concentrated sulfuric acid were dissolved in 150 ml of toluene, and the resulting solution was allowed to react under reflux for 2 hours. The reaction solution was washed with a sodium bicarbonate aqueous solution, subsequently with distilled water, dried over sodium sulfate anhydride, and concentrated, whereby a crude product was obtained. The crude product was refined by column chromatography to obtain 6.3 g of Monomer (A).

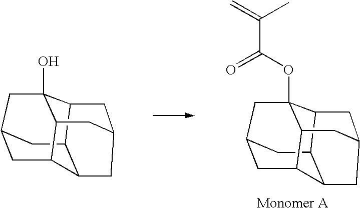

### Synthesis Example 2

### Synthesis of Monomer (B)

Bromine (160 ml) was cooled to −7° C., and 40 g of diamantane was gradually added thereto while maintaining the temperature of the reaction solution −3° C. or lower. After that, 2.16 g of aluminum bromide was gradually added while maintaining the temperature of the reaction solution 0° C. or lower. The reaction solution was stirred at −7° C. for 30 minutes, and then slowly poured into a solution comprising 500 g of sodium sulfite, 160 g of sodium hydroxide, and 3 liters of water. The precipitate was filtered out and washed with acetonitrile, whereby 63 g of dibromodiamantane was obtained.

To 20 g of the dibromodiamantane was slowly added 80 ml of concentrated nitric acid, the solution was heated at 70° C. and allowed to react for 30 minutes. The reaction solution was poured into 300 ml of water, and 72 g of sodium hydroxide and 500 ml of water were added thereto to make the solution alkaline. The precipitate was filtered out and washed with water, whereby 7 g of dihydroxydiamantane was obtained.

By the similar means as the synthesis of Monomer (A) with the dihydroxydiamantane, 3 g of Monomer (B) was obtained.

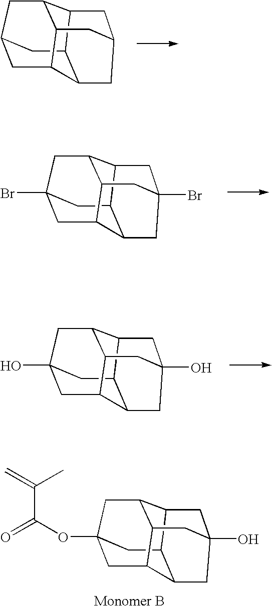

### Synthesis Example 3

### Synthesis of Resin (RA-1) (Dropping Polymerization)

Propylene glycol monomethyl ether acetate (5.1 g) and 3.4 g of propylene glycol monomethyl ether were put into a three neck flask under nitrogen current and heated at 80° C. Thereto was dropped over 6 hours a solution comprising 46 g of propylene glycol monomethyl ether acetate and 30.7 g of propylene glycol monomethyl ether having dissolved therein 2.7 g of Monomer (A), 4.7 g of 3-hydroxyadamantane acrylate, 7.0 g of 2-methyl-2-adamantyl methacrylate, 6.8 g of γ-butyrolactone, and a polymerization initiator V-601 (manufactured by Wako Pure Chemical Industries) in proportion of 4 mol % based on the polymer. After finishing dropping, the reaction solution was further reacted at 80° C. for 2 hours. After being allowed to cool, the reaction solution was poured into 720 ml of hexane and 80 ml of ethyl acetate, and the precipitated powder was filtered out and dried to thereby obtain 17 g of Resin (RA-1). The weight average molecular weight of Resin (RA-1) as the polystyrene equivalent by the GPC method was 9,600, and the degree of dispersion (Mw/Mn) was 1.80.

Resins (RA-2) to (Ra-18) were synthesized in the same manner.

### Synthesis Example 4

### Synthesis of Comparative Resin (RA-1′)

Comparative Resin (RA-1′) was synthesized in the same manner as in Synthesis Example 3, except for changing 3-hydroxyadamantane acrylate with 3-hydroxyadamantane methacrylate. The weight average molecular weight of Comparative Resin (RA-1′) as the polystyrene equivalent by the GPC method was 10,700, and the degree of dispersion (Mw/Mn) was 1.81.

The structures, compositional ratios (molar ratios), weight average molecular weights and the degrees of dispersion of Resins (RA-1) to (RA-18) and Comparative Resin (RA-1′) are shown below.

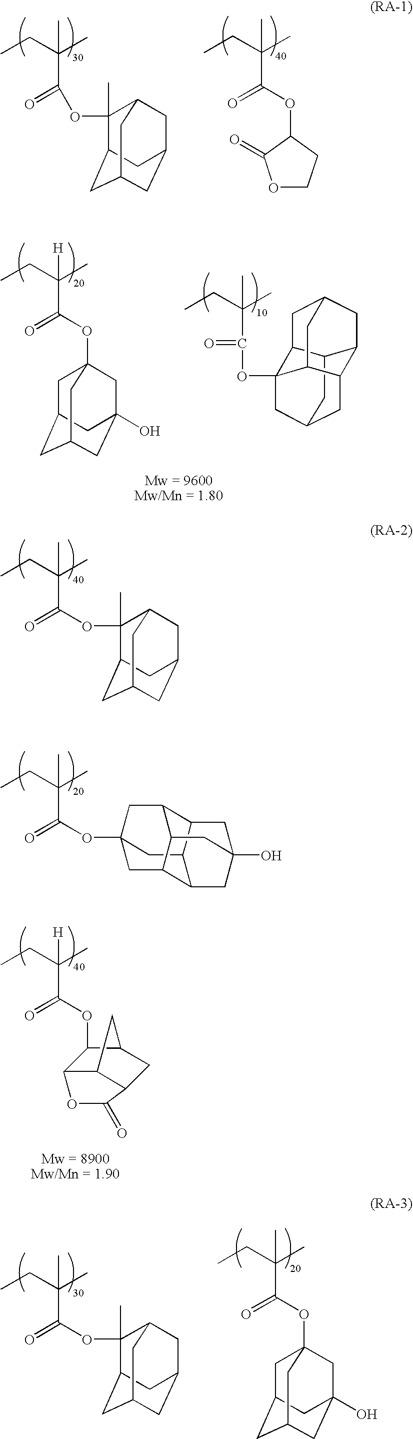

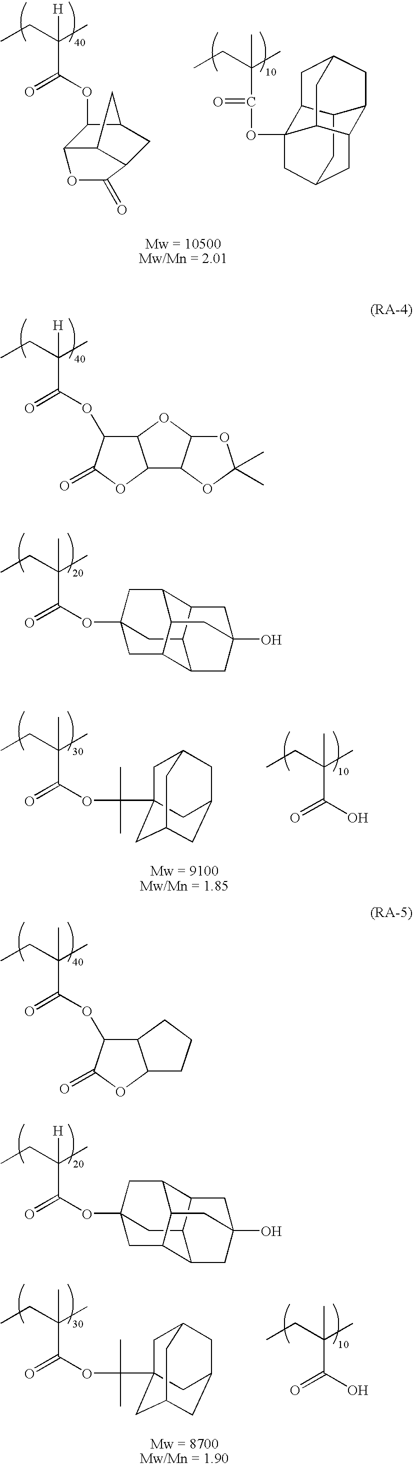

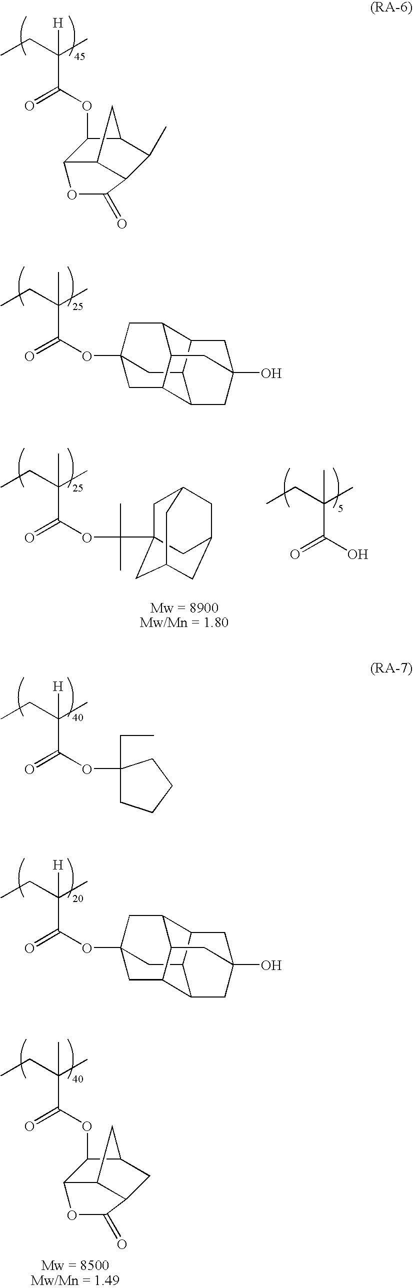

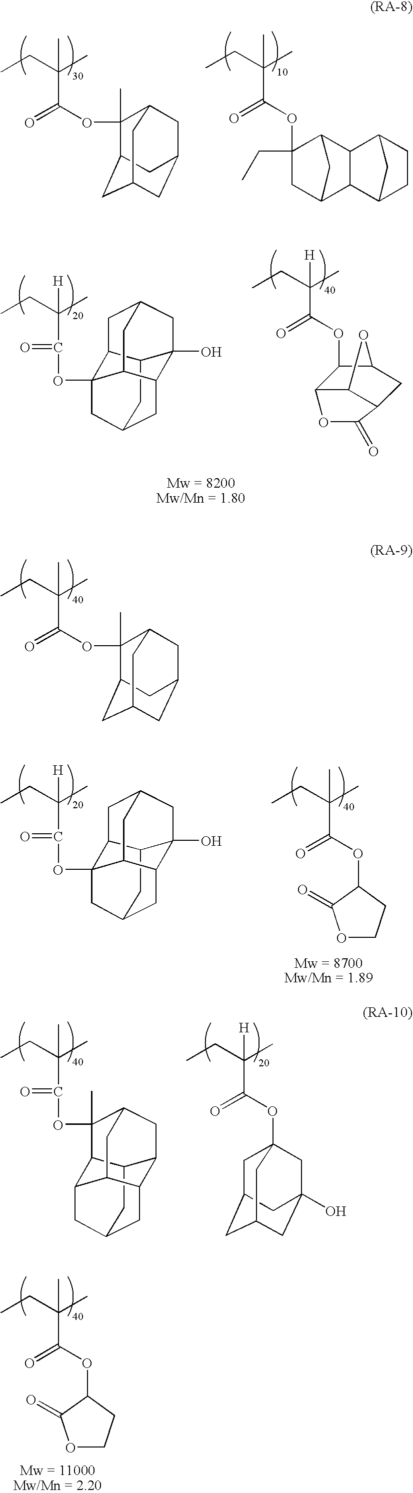

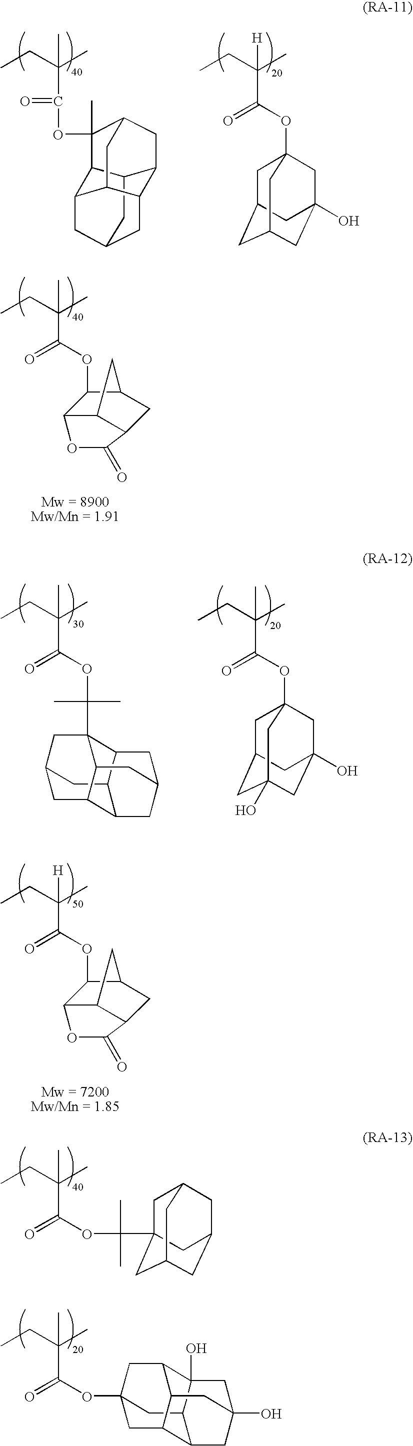

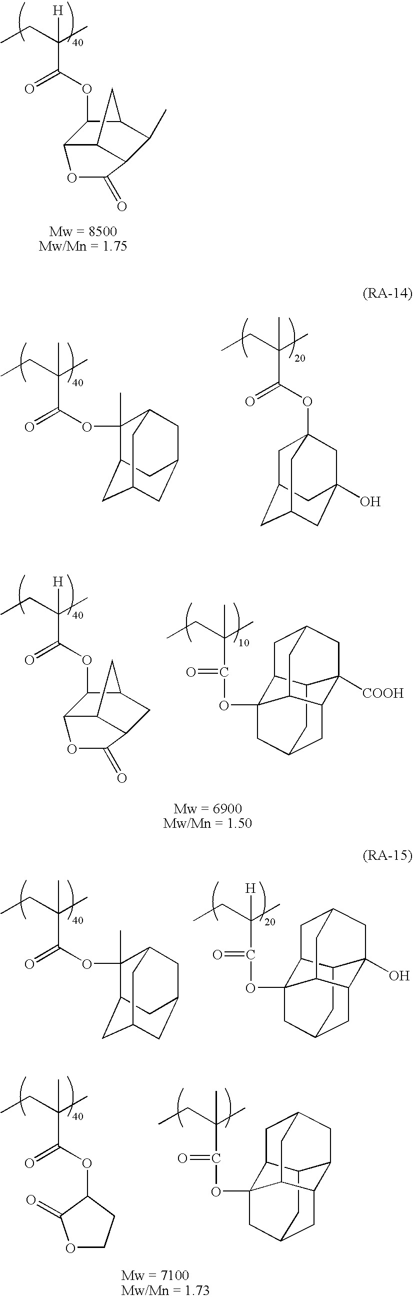

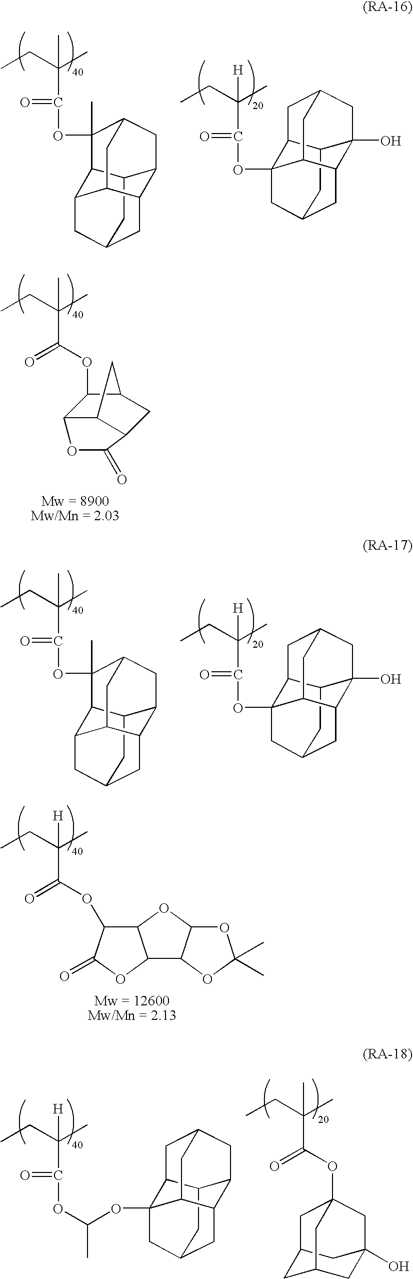

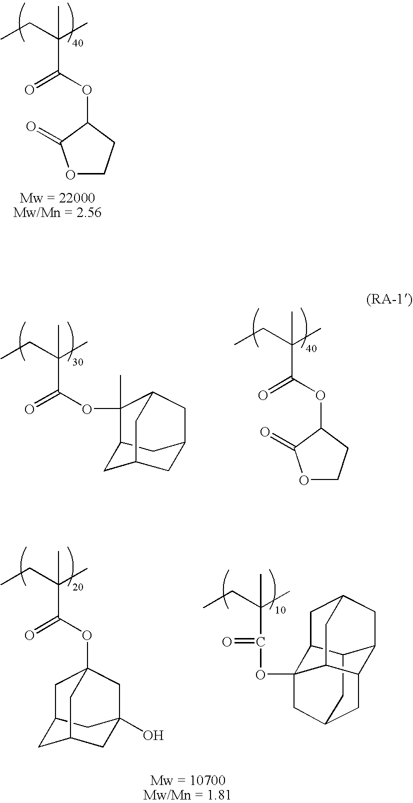

### Examples 1 to 21 and Comparative Example 1

Preparation of Resist:

The components shown in Table 1 below were dissolved in the solvents to prepare a solution having solid concentration of 9 mass %. The obtained solution was filtered through a polyethylene filter having a pore diameter of 0.03 μm, whereby a positive resist solution was prepared. Each of the obtained positive resist solutions was evaluated according to the methods shown below, and the results obtained are shown in Table 1.

TABLE 1

| | | | | | | | PEB |
|---|---|---|---|---|---|---|---|
| | Acid | | Basic | | | Exposure | Temperature |
| Example | Generator | Resin | Compound | Surfactant | Solvent | Latitude | Dependency |
| No. | (g) | (10 g) | (g) | (g) | (mass ratio) | (%) | (nm/° C.) |
| Example 1 | z2 (0.3) | RA-1 | DIA (0.03) | w-4 (0.01) | S1/S5 = 60/40 | 18.3 | 2.1 |
| Example 2 | z2 (0.3) | RA-2 | TPA (0.05) | w-2 (0.02) | S1/S4/S6 = 80/5/15 | 18.6 | 2.2 |
| Example 3 | z63 (0.2) | RA-3 | HAP (0.02) | w-1 (0.01) | S1/S6 = 95/5 | 18.2 | 2.4 |
| Example 4 | z23 (0.3) | RA-4 | DIA (0.03) | w-4 (0.01) | S1/S5 = 60/40 | 19.4 | 1.9 |
| Example 5 | z15 (0.2) | RA-5 | PEA (0.02) | w-4 (0.01) | S1/S5 = 80/20 | 19.2 | 1.9 |
| Example 6 | z2 (0.2) | RA-6 | DIA (0.02) | w-4 (0.01) | S1/S4/S6 = 80/5/15 | 19.0 | 2.0 |
| | z30 (0.2) | | PEA (0.02) | | | | |
| Example 7 | z16 (0.3) | RA-7 | TMEA (0.03) | w-3 (0.03) | S1/S5 = 60/40 | 17.1 | 2.6 |
| Example 8 | z55 (0.3) | RA-8 | TBAH (0.04) | w-1 (0.005) | S1/S6 = 80/20 | 17.9 | 2.7 |
| Example 9 | z51 (0.5) | RA-9 | HAP (0.03) | w-3 (0.02) | S1/S5 = 60/40 | 19.1 | 1.9 |
| Example 10 | z2 (0.3) | RA-10 | TPSA (0.05) | w-3 (0.01) | S1/S5 = 60/40 | 18.0 | 2.2 |
| Example 11 | z44 (0.2) | RA-11 | DCMA (0.03) | w-4 (0.01) | S1/S3 = 60/40 | 18.0 | 2.2 |
| Example 12 | z2 (0.3) | RA-12 | DIA (0.03) | w-4 (0.01) | S1/S5 = 60/40 | 18.1 | 2.3 |
| Example 13 | z23 (0.4) | RA-13 | PEA (0.01) | w-2 (0.02) | S1/S5 = 60/40 | 18.4 | 2.5 |
| Example 14 | z2 (0.5) | RA-14 | PEA (0.04) | w-4 (0.01) | S1/S3 = 60/40 | 18.2 | 2.4 |
| Example 15 | z23 (0.1) | RA-15 | DIA (0.02) | w-2 (0.02) | S1/S5 = 60/40 | 19.2 | 2.0 |
| | z46 (0.3) | | PEA (0.02) | | | | |
| Example 16 | z55 (0.2) | RA-16 | DIA (0.02) | w-2 (0.01) | S1/S3 = 60/40 | 17.9 | 2.1 |
| | z51 (0.2) | | PEA (0.02) | | | | |
| Example 17 | z23 (0.2) | RA-17 | DIA (0.02) | w-4 (0.01) | S1/S3 = 60/40 | 18.2 | 2.4 |
| | z55 (0.4) | | PEA (0.02) | | | | |
| Example 18 | z62 (0.4) | RA-18 | DIA (0.02) | w-4 (0.01) | S1/S5/S7 = 59/40/1 | 17.3 | 2.0 |
| | z65 (0.1) | | PEA (0.02) | | | | |
| Example 19 | z59 (0.3) | RA-1 (5 g) | DIA (0.02) | w-4 (0.01) | S1/S5/S7 = 59/40/1 | 18.5 | 2.3 |
| | | RA-2 (5 g) | PEA (0.02) | | | | |
| Example 20 | z2 (0.3) | RA-1 | DIA (0.03) | w-4 (0.01) | S3 = 100 | 19.2 | 2.7 |
| Example 21 | z2 (0.3) | RA-1 (9 g) | DIA (0.03) | w-4 (0.01) | S3/S4 = 95/5 | 18.7 | 2.5 |
| | | B2-6* (1 g) | | | | | |
| Comparative | z2 (0.3) | RA-1′ | DIA (0.03) | w-4 (0.01) | S1/S5 = 60/40 | 17.0 | 4.6 |
| Euxample 1 | | | | | | | |

B2-6*: Average molecular weight: 7,300, degree of dispersion: 1.65

The abbreviations in Table 1 are shown below.

Basic Compounds:

TPI: 2,4,5-Triphenylimidazole
TPSA: Triphenylsulfonium acetate
DIA: 2,6-Diisopropylaniline
DCMA: Dicyclohexylmethylamine
TPA: Tripentylamine
HAP: Hydroxyantipyrine
TBAH: Tetrabutylammonium hydroxide
TMEA: Tris(methoxyethoxyethyl)amine
PEA: N-Phenyldiethanolamine
   Surfactants:
W-1: Megafac F176 (fluorine surfactant, manufactured by Dainippon Ink and Chemicals Inc.)
W-2: Megafac R08 (fluorine/silicon surfactant, manufactured by Dainippon Ink and Chemicals Inc.)
W-3: Polysiloxane polymer KP-341 (silicon surfactant, manufactured by Shin-Etsu Chemical Co., Ltd.)
W-4: Troy Sol S-366 (manufactured by Troy Chemical Co., Ltd.)
S1: Propylene glycol methyl ether acetate
S2: 2-Heptanone
S3: Cyclohexanone
S4: γ-Butyrolactone
S5: Propylene glycol methyl ether
S6: Ethyl lactate
S7: Propylene carbonate
   Evaluation of Resist:

Antireflection film DUV-42 (manufactured by Brewer Science) was uniformly coated in a thickness of 600 Å by a spin coater on a silicone substrate treated with hexamethyl-disilazane, dried on a hot plate at 100° C. for 90 seconds, and then dried with heating at 190° C. for 240 seconds. After that, each positive resist solution was coated thereon by a spin coater and dried at 110° C. for 90 seconds to form a resist film having a thickness of 180 nm.

The resist film was subjected to exposure through a mask with an ArF excimer laser stepper (manufactured by ASML Co., NA=0.75, ⅔ zonal illumination), and the exposed resist film was heated on a hot plate at 120° C. for 90 seconds immediately after exposure. Further, the resist film was developed with a 2.38 mass % tetramethylammonium hydroxide aqueous solution at 23° C. for 60 seconds, rinsed with pure water for 30 seconds, and then dried, whereby a line pattern was obtained.

Exposure Latitude:

Taking the exposure amount required to reproduce the mask pattern of line and space of line width 80 nm as the optimal exposure amount, the breadth of exposure amount tolerating 80 nm±10% of a pattern size when exposure amount was varied was found. The obtained value was divided by the optimal exposure amount and the exposure latitude was shown in percentage. The greater the value, the smaller is the fluctuation of performance by the variation of exposure amount, and exposure latitude is good.

PEB Temperature Dependency:

When post baking was performed at 120° C. for 90 seconds, the exposure amount required to reproduce line and space 1/1 of mask size 80 nm was taken as the optimal exposure amount. After exposure by the optimal exposure amount, post baking at two temperatures of post baking temperature +2° C. and −2° C. (122° C. and 118° C.) was performed, and each line and space obtained was measured and line widths L₁ and L₂ were found. PEB temperature dependency was defined as fluctuation of line width per 1° C. of PEB temperature change, and computed from the following expression.
PEB Temperature dependency (nm/° C.)=|L₁−L₂|/4

The smaller the value, the smaller is the fluctuation of performance to the variation of temperature.

It can be clearly seen from the results shown in Table 1 that the positive photosensitive compositions in the invention are improved in exposure latitude and PEB temperature dependency.

Immersion Exposure

Preparation of Resist:

Each of the components in Examples 1 to 21 and Comparative Example 1 shown in Table 1 was dissolved in the solvents to prepare a solution having solid concentration of 7 mass %, and the solution was filtered through a polyethylene filter having a pore diameter of 0.03 μm, whereby a positive resist solution was prepared. Each prepared positive resist solution was evaluated according to the following method.

Evaluation of Resolution:

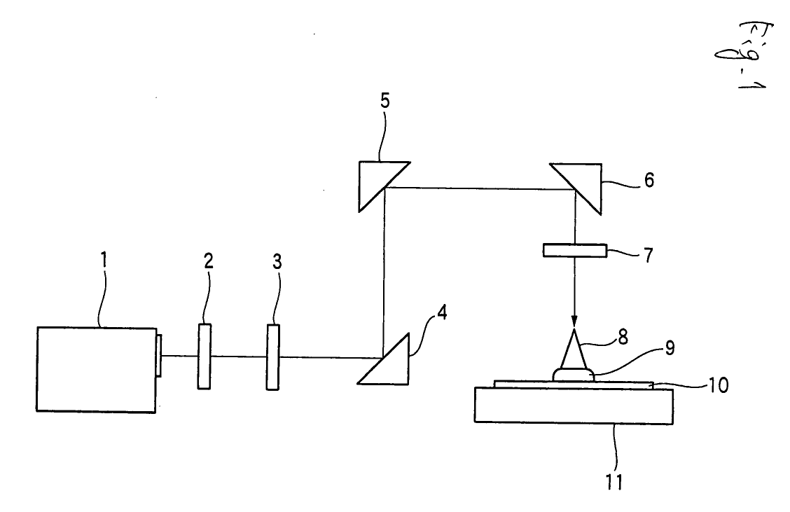

An organic antireflection film ARC29A (manufactured by Nissan Chemical Industries, Ltd.) was coated on a silicone wafer, and the coating was baked at 205° C. for 60 seconds to thereby form an antireflection film having a thickness of 78 nm. The above-prepared positive resist solution was coated on the antireflection film and baked at 115° C. for 60 seconds, whereby a resist film having a thickness of 150 nm was formed. The obtained wafer was subjected to two-beam interference exposure with pure water as the immersion liquid (wet exposure). In the two-beam interference exposure (wet exposure), as shown in FIG. 1, wafer 10 having an antireflection film and a resist film was exposed via prism 8 and immersion liquid 9 (pure water) with laser 1, diaphragm 2, shutter 3, three reflection mirrors 4, 5 and 6, and condenser lens 7. The wavelength of laser 1 was 193 nm, and prism 8 for forming line and space pattern of 65 nm was used. Immediately after exposure, the wafer was baked at 115° C. for 90 seconds, developed with a tetramethylammonium hydroxide aqueous solution (2.38%) for 60 seconds, rinsed with pure water, and dried with spinning to obtain a resist pattern. The obtained resist pattern was observed with a scanning electron microscope S9260 (manufactured by Hitachi, Ltd.). In the cases where the positive resist solutions in Examples 1 to 21 were used, line and space patterns were resolved without causing pattern collapse. On the other hand, in the case where the positive resist solution in Comparative Examples 1 was used, pattern collapse was partly observed, although line and space pattern of 65 nm was resolved.

It is apparent that the positive photosensitive compositions according to the invention have good image forming property in an exposure method using an immersion liquid.

The invention can provide a positive photosensitive composition in which PEB temperature dependency and exposure latitude are improved, and a pattern-forming method using the same.

The entire disclosure of each and every foreign patent application from which the benefit of foreign priority has been claimed in the present application is incorporated herein by reference, as if fully set forth.

What is claimed is:

1. A positive photosensitive composition comprising:
(A) a compound capable of generating an acid upon irradiation with actinic ray or radiation; and
(B) a resin having a group capable of decomposing by action of an acid to increase solubility of the group in an alkali developer,
wherein the resin (B) has a diamantane structure, and comprises:
at least one methacrylate repeating unit; and
at least one acrylate repeating unit.

2. The positive photosensitive composition as claimed in claim 1,
wherein a repeating unit (Ba) having the diamantane structure in the resin (B) is at least one repeating unit selected from the following (Ba-1) and (Ba-2):
(Ba-1) a repeating unit having a group capable of decomposing by action of an acid to increase solubility of the group in an alkali developer, and having the diamantane structure in the group being desorbed by the action of an acid, and
(Ba-2) a repeating unit having the diamantane structure and not influenced by the action of an acid or an alkali.

3. The positive photosensitive composition as claimed in claim 2,
wherein the sub group in the repeating unit (Ba-1) is represented by any of formulae (DpI) to (DpV): 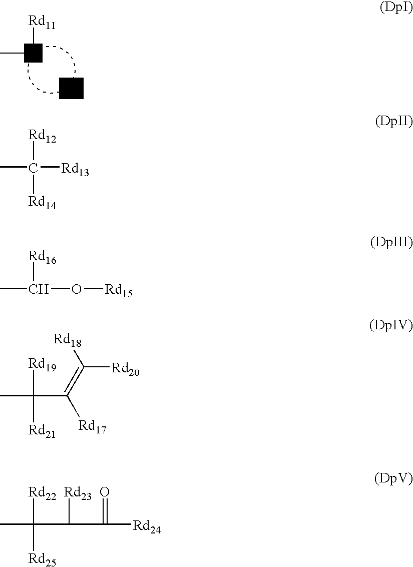
wherein, Rd₁₁ represents a methyl group, an ethyl group, an n-propyl group, an isopropyl group, an n-butyl group, an isobutyl group, or a sec-butyl group; and Zd represents an atomic group necessary to form a diamantyl group together with a carbon atom;
Rd₁₂, Rd₁₃, Rd₁₄, Rd₁₅ and Rd₁₆ each represents a straight chain or branched alkyl group having from 1 to 4 carbon atoms, or a cycloalkyl group, provided that at least one of Rd₁₂ to Rd₁₄, or either Rd₁₅ or Rd₁₆, represents a diamantyl group or a group having a diamantyl group;
Rd₁₇, Rd₁₈, Rd₁₉, Rd₂₀ and Rd₂₁ each represents a hydrogen atom, a straight chain or branched alkyl group having from 1 to 4 carbon atoms, or a cycloalkyl group, provided that at least one of Rd₁₇ to Rd₂₁ represents a diamantyl group or a group having a diamantyl group, and either Rd₁₉ or Rd₂₁ represents a straight chain or branched alkyl group having from 1 to 4 carbon atoms, or a cycloalkyl group;
Rd₂₂, Rd₂₃, Rd₂₄ and Rd₂₅ each represents a hydrogen atom, a straight chain or branched alkyl group having from 1 to 4 carbon atoms, or a cycloalkyl group, provided that at least one of Rd₂₂ to Rd₂₅ represents a diamantyl group or a group having a diamantyl group, and Rd₂₃ and Rd₂₄ may be bonded to each other to form a ring.

4. The positive photosensitive composition as claimed in claim 3,
wherein the repeating unit (Ba-1) is represented by formula (DPA): 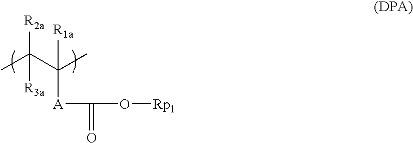
wherein, R₁ₐ, R₂ₐ and R₃ₐ each represents a hydrogen atom, a halogen atom, or a straight chain or branched substituted or unsubstituted alkyl group having from 1 to 4 carbon atoms;
A represents a single group or a combination comprising two or more groups selected from the group consisting of a single bond, an alkylene group, an ether group, a thioether group, a carbonyl group, an ester group, an amido group, a sulfonamido group, a urethane group, and a urea group, and preferably a single bond; and
Rp₁ represents a group represented by any of the formulae (DpI) to (DpV).

5. The positive photosensitive composition as claimed in claim 2,
wherein the repeating unit (Ba-2) is represented by formula (DPB): 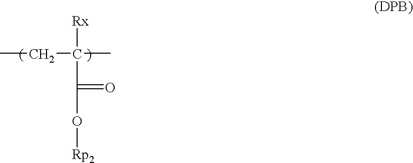
wherein, Rx represents H, CH₃, CF₃, or CH₂OH;
Rp₂ represents a diamantyl group or a group having a diamantyl group, which is a group not desorbed from the oxygen atom by the action of an acid or an alkali.

6. The positive photosensitive composition as claimed in claim 1,
wherein the resin of component (B) comprises:
at least one repeating unit having a group capable of decomposing by the action of an acid to increase solubility of the group in an alkali developer; and
at least one repeating unit selected from a repeating unit having a lactone group, and a repeating unit having a hydroxyl group or a cyano group.

7. A pattern forming method comprising:
forming a photosensitive film with the positive photosensitive composition as claimed in claim 1; and
exposing and developing the photosensitive film.
